(19) United States
(12) Patent Application Publication
(10) Pub. No.: US 2015/0235008 A1
(43) Pub. Date: Aug. 20, 2015

(54) INFORMATION PROCESSING SYSTEM AND NON-TRANSITORY COMPUTER READABLE RECORDING MEDIUM

(71) Applicant: Konica Minolta, Inc., Tokyo (JP)

(72) Inventors: Kosuke SASAI, Kobe-shi (JP); Hiroaki MATSUMOTO, Yokohama-shi (JP)

(21) Appl. No.: 14/625,841

(22) Filed: Feb. 19, 2015

(30) Foreign Application Priority Data
Feb. 20, 2014 (JP) 2014-030821

(51) Int. Cl. G06F 19/00; G06F 3/0482; G06T 11/60; G06F 3/0484

(52) U.S. Cl. CPC G06F 19/3487; G06F 3/0484; G06F 3/0482; G06T 11/60; G06T 2200/24; G06T 2210/41

(57) ABSTRACT

A combination group includes combinations of elements belonging to items. When an attention location in a medical image is designated, two or more elements corresponding to the attention location and belonging to the first item are identified. When one of the two or more elements is designated, two or more elements belonging to a second item and included in one or more combinations of elements included in the combination group and corresponding to the designated one element are displayed to be distinguishable from the other elements. When one or more of the two or more displayed elements are designated, one or more elements belonging to a third item and included in at least one combination of elements included in the combination group and corresponding to a combination of the one designated element and each of the one or more designated elements are displayed to be distinguishable from the other elements.

The present U.S. patent application claims a priority under the Paris Convention of Japanese patent application No. 2014-030821 filed on Feb. 20, 2014, the entirety of which incorporated by references.

### BACKGROUND OF THE INVENTION

1. Field of the Invention

The present invention relates to an information processing system and a non-transitory computer readable recording medium.

2. Description of the Background Art

In medical settings, image diagnosis is made by doctors observing lesions while displaying medical images generated by various modalities, and thereby obtaining findings. In image diagnosis, doctors create reports that show diagnostic results including finding sentences.

The reports include a plurality of items such as a shooting condition, a basic body part, basic findings and diagnosis for which various terms should be input. Creating such reports thus becomes a heavy burden for doctors.

To address the problem, technology for detecting an abnormality included in an image, and creating a radiologic interpretation report with use of a combination of a type and a location of the abnormality has been proposed for the purpose of supporting creation of reports showing diagnostic results, for example (e.g., Japanese Patent No. 3332104).

With the above-mentioned technology disclosed in Japanese Patent No. 3332104, however, an anatomy captured in an image is that in a two-dimensional coordinate system, and a location of an abnormality is detected only from, for example, six locations such as left and right upper lung fields, left and right middle lung fields, and left and right lower lung fields. As such, with the above-mentioned technology disclosed in Japanese Patent No. 3332104, it is difficult to accurately detect locations of abnormalities from three-dimensional anatomies, which are subjects captured in medical images generated by various modalities, and to efficiently create proper finding sentences.

### SUMMARY OF THE INVENTION

An object of the present invention is therefore to provide technology for efficiently and properly creating diagnostic reports.

To achieve the above-mentioned object, an information processing system reflecting one aspect of the present invention includes a storage, a location designation unit, a body part identification unit, a body part designation unit, a display controller, and an element designation unit. The storage is capable of storing therein a combination information group that indicates a plurality of combinations of elements that belong to a plurality of items. The plurality of items include a first item concerning a body part in a three-dimensional anatomy, and a second item and a third item each different from the first item. The location designation unit designates, in accordance with a user action, an attention location in a medical image displayed by a display unit. The body part identification unit identifies, from among elements that belong to the first item, two or more elements that correspond to the attention location. The body part designation unit designates, in accordance with a user action, one of the two or more elements identified by the body part identification unit. The display controller causes the display unit to display, based on one or more combinations of elements that are indicated by the combination information group and correspond to the one element designated by the body part designation unit, two or more elements that are included in the one or more combinations of elements and belong to the second item so that the two or more displayed elements are distinguishable from the other elements. The element designation unit designates, in accordance with a user action, one or more of the two or more elements that belong to the second item and are displayed by the display unit. The display controller causes the display unit to display, based on at least one combination of elements that is indicated by the combination information group and corresponds to a combination of the one element designated by the body part designation unit and each of the one or more elements designated by the element designation unit, one or more elements that are included in the at least one combination of elements and belong to the third item so that the one or more displayed elements are distinguishable from the other elements.

Another aspect of the present invention is also directed to a non-transitory computer readable recording medium storing a computer-readable program, the program controlling an information processing system to operate as one information processing system. The one information processing system includes a storage, a location designation unit, a body part identification unit, a body part designation unit, a display controller, and an element designation unit. The storage is capable of storing therein a combination information group that indicates a plurality of combinations of elements that belong to a plurality of items. The plurality of items include a first item concerning a body part in a three-dimensional anatomy, and a second item and a third item each different from the first item. The location designation unit designates, in accordance with a user action, an attention location in a medical image displayed by a display unit. The body part identification unit identifies, from among elements that belong to the first item, two or more elements that correspond to the attention location. The body part designation unit designates, in accordance with a user action, one of the two or more elements identified by the body part identification unit. The display controller causes the display unit to display, based on one or more combinations of elements that are indicated by the combination information group and correspond to the one element designated by the body part designation unit, two or more elements that are included in the one or more combinations of elements and belong to the second item so that the two or more displayed elements are distinguishable from the other elements. The element designation unit designates, in accordance with a user action, one or more of the two or more elements that belong to the second item and are displayed by the display unit. The display controller causes the display unit to display, based on at least one combination of elements that is indicated by the combination information group and corresponds to a combination of the one element designated by the body part designation unit and each of the one or more elements designated by the element designation unit, one or more elements that are included in the at least one combination of elements and belong to the third item so that the one or more displayed elements are distinguishable from the other elements.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an example of an overall configuration of an information processing system according to one embodiment;

FIG. 2 is a block diagram showing main components of the information processing system according to the one embodiment;

FIG. 3 shows an example of contents of medical care information;

FIG. 4 shows an example of contents of support information;

FIG. 5 shows a specific example of location correspondence information;

FIG. 6 shows a specific example of priority information;

FIG. 7 shows examples of a finding sentence;

FIG. 8 shows an example of the structure of the finding sentences;

FIG. 9 shows a specific example of term information;

FIG. 10 shows a specific example of combination frequency information;

FIG. 11 is a block diagram showing functional components for implementing diagnosis support processing;

FIG. 12 is a flow chart showing an operation flow of the diagnosis support processing;

FIG. 13 is a flow chart showing the operation flow of the diagnosis support processing;

FIG. 14 is a flow chart showing the operation flow of the diagnosis support processing;

FIG. 15 shows an example of an examination list screen;

FIG. 16 shows an example of a creation support screen;

FIGS. 17A to 17E show an example of a third area;

FIG. 18 shows an example of a fourth area;

FIG. 19 is a diagram for describing a method for setting a diagnostic area in a medical image;

FIG. 20 shows an example of designation of a body part on a medical image;

FIG. 21 shows an example of an attention location on the medical image;

FIG. 22 shows an example of the attention location in an anatomical model;

FIG. 23 shows an example of a method for identifying candidates for a term concerning a basic body part;

FIG. 24 shows the example of the method for identifying candidates for the term concerning the basic body part;

FIG. 25 shows the example of the method for identifying candidates for the term concerning the basic body part;

FIGS. 26A to 26E show an example of a support template in which a left middle lung field is designated;

FIG. 27 shows an example of a detail window;

FIGS. 28A to 28E show an example of a support template in which a middle lung field and nodular shadow are designated;

FIGS. 29A to 29E show an example of a support template in which a hilum of a left lung is designated;

FIGS. 30A to 30E show an example of a support template in which a left rib is designated;

FIGS. 31A to 31E show an example of a support template in which a hilum of a left lung and dilatation are designated;

FIGS. 32A to 32E show an example of a support template in which a left rib and hardening are designated;

FIG. 33 shows an example of a finding window according to a modification; and

FIG. 34 shows an example of a diagnosis window according to the modification.

### DETAILED DESCRIPTION OF THE INVENTION

The following describes one embodiment and modifications of the present invention based on the drawings. It should be noted that components having a similar structure and function bear the same reference sign in the drawings, and repetition of description thereof is avoided below. The drawings are those shown schematically, and sizes of and positional relationships among various components in each of the drawings are not accurate, and may be changed as appropriate.

### <(1) Overall Configuration of Information Processing System>

FIG. 1 shows an example of an overall configuration of an information processing system 1 according to the one embodiment. The information processing system 1 is a system installed in a medical institution, such as a hospital, and includes a server 10, a modality 20, and a terminal device 30 as shown in FIG. 1, for example. The server 10, the modality 20, and the terminal device 30 are connected to one another via a communication line W1 for data transmission/reception. The communication line W1 may be wired or wireless. In the present embodiment, the communication line W1 is a local area network (LAN) line.

The server 10 is a computing device that stores therein data on a medical image which is acquired by the modality 20 and in which three-dimensional anatomical components as subjects are captured. In response to a request from the terminal device 30, the server 10 provides data on a desired medical image to the terminal device 30. The server 10 has various functions to perform processing (also referred to as diagnosis support processing) to support a diagnostic action taken with respect to a medical image by use of the terminal device 30. The diagnosis support processing includes processing to support creation of a report (also referred to as a diagnostic result report) that shows a result of diagnosis made with respect to the medical image, for example. The diagnostic result report includes a radiologic interpretation report that shows a result of radiologic interpretation, for example.

The modality 20 is a device that acquires data on a medical image in which three-dimensional anatomical components as subjects are captured. Examples of the modality 20 are a computed radiography (CR) device, an ultrasound diagnostic (US) device and the like. A subject of shooting is not limited to a human, and may be other animals. Examples of the three-dimensional anatomical components are various organs, bones, joints, and the like included in a chest area.

The terminal device 30 is in the form of a personal computer (hereinafter, abbreviated as a PC), for example, and is a terminal device into which a diagnostic result report is input by a user, such as a doctor, who has specialized medical knowledge.

### <(2) Main Components of Information Processing System>

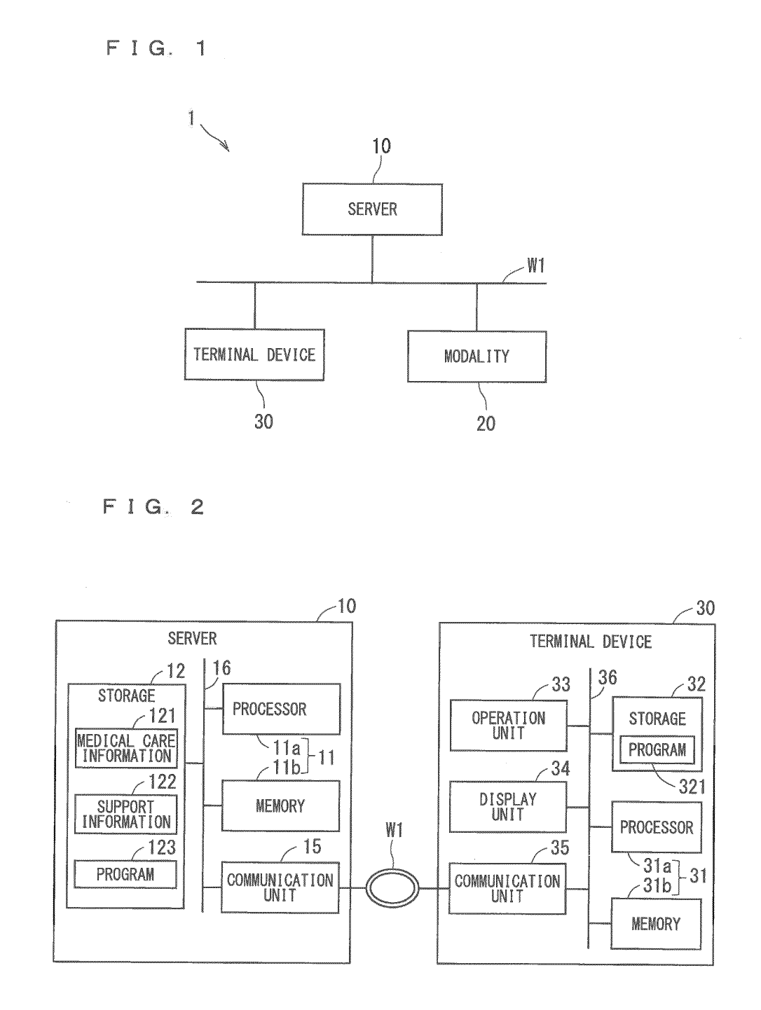

FIG. 2 is a block diagram showing main components of the information processing system 1 according to the one embodiment. As shown in FIG. 2, the server 10 has a configuration in which a controller 11, a storage 12, and a communication unit 15 are connected to a bus line 16, for example. The bus line 16 is connected to the communication line W1 via the communication unit 15. The terminal device 30 has a configuration in which a controller 31, a storage 32, an operation unit 33, a display unit 34, and a communication unit 35 are connected to a bus line 36. The bus line 36 is connected to the communication line W1 via the communication unit 35.

### <(2-1) Server>

The controller 11 includes a processor 11a, such as a central processing unit (CPU), and volatile memory 11b, such as random access memory (RAM), for example. The processor 11a achieves the diagnosis support processing by reading a program 123 stored in the storage 12 and performing a variety of processing in accordance with the program 123. That is to say, functions of the information processing system 1 to perform the diagnosis support processing are achieved by the processor 11a executing the program 123.

The storage 12 includes non-volatile semiconductor memory or a hard disk, for example. The storage 12 can store therein medical care information 121, support information 122, and the program 123. The storage 12 can also store therein a variety of data that indicates a parameter and the like that are required to perform processing in accordance with the program 123 and data that is at least temporarily generated as a result of arithmetic processing, for example.

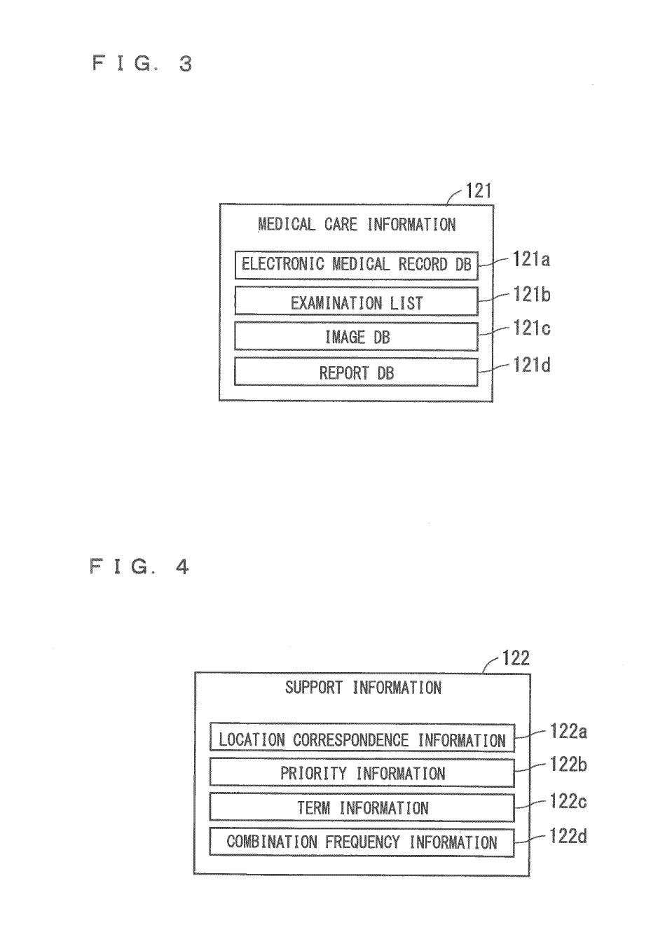

FIG. 3 shows an example of contents of the medical care information 121. As shown in FIG. 3, the medical care information 121 includes an electronic medical record database (electronic medical record DB) 121a, an examination list 121b, an image database (image DB) 121c, and a report database (report DB) 121d, for example.

The electronic medical record DB 121a stores therein data on electronic medical records of many patients, for example.

The examination list 121b is a list of basic information pieces on many examinations, for example. The basic information pieces include information pieces on identification information (an ID) of a subject, a name, a birth date, age, sex, a state regarding creation of a diagnostic result report, identification information of an examination (an examination ID), an examination date, an examined body part, a modality that has acquired a medical image, and the number of medical images, for example. The state regarding creation of a diagnostic result report includes a state (also referred to as a not created state) in which a diagnostic result report has not been created and a state (also referred to as a created state) in which a diagnostic result report has been created.

The image DB 121c stores therein, for each of the examinations listed in the examination list 121b, data on a medical image acquired by the modality 20 in association with identification information, such as an examination ID, listed in the examination list.

The report DB 121d stores therein, for each of the examinations listed in the examination list 121b, data on a diagnostic result report in association with identification information, such as an examination ID, listed in the examination list 121b.

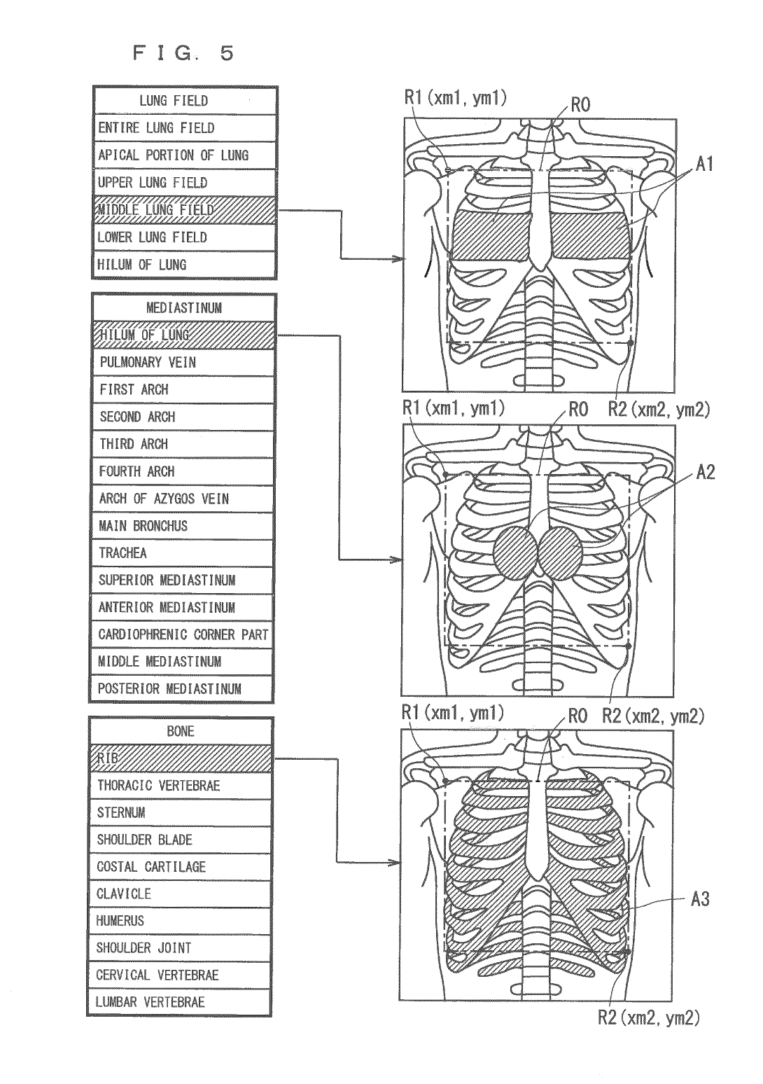

FIG. 4 shows an example of contents of the support information 122. As shown in FIG. 4, the support information 122 includes location correspondence information 122a, priority information 122b, term information 122c, and combination frequency information 122d, for example.

The location correspondence information 122a is information that associates information pieces on locations in a predetermined model (an anatomical model) concerning a three-dimensional anatomy with elements that belong to an item showing a basic body part in the three-dimensional anatomy. In the present embodiment, the elements that belong to the item showing the basic body part are each a term showing a name of the basic body part. That is to say, the location correspondence information 122a includes information that associates terms showing names of a plurality of basic body parts that indicate anatomical sections of a human body with information pieces on locations of predetermined areas in a preset anatomical model.

FIG. 5 illustrates contents of the location correspondence information 122a. As illustrated in FIG. 5, terms showing names of basic body parts that indicate anatomical sections in a chest area are associated with respective information pieces on locations of predetermined areas in the preset anatomical model for each of categories (a lung field, a mediastinum, and a bone). Terms showing names of basic body parts that belong to a category “lung field” include an entire lung field, an apical portion of a lung, . . . , and a hilum of a lung. Terms showing names of basic body parts that belong to a category “mediastinum” include a hilum of a lung, a pulmonary vein, . . . , and a posterior mediastinum. Terms showing names of basic body parts that belong to a category “bone” include a rib, thoracic vertebrae, . . . , and lumbar vertebrae.

FIG. 5 illustrates: a middle lung field as an anatomical section and an area A1 in the anatomical model that corresponds to the middle lung field; a hilum of a lung as an anatomical section and an area A2 in the anatomical model that corresponds to the hilum of the lung; and a rib as an anatomical section and an area A3 in the anatomical model that corresponds to the rib. The areas A1-A3 can be set beforehand as predetermined areas based on anatomical knowledge, for example.

As illustrated in FIG. 5, a reference area R0 (an area surrounded by an alternate long and short dash line in FIG. 5) is set in advance in the anatomical model. The reference area R0 defines an anatomical area as a reference, when body part identification processing, which is described later, is performed. In the example of FIG. 5, coordinates (xm1, ym1) of an upper left point R1 and coordinates (xm2, ym2) of a lower right point R2 of the reference area R0 are set. Settings of the reference area R0 can optionally be changed by a user. In the example of FIG. 5, the anatomical model corresponds to a frontal view in which a three-dimensional anatomy in a chest area is captured (also referred to as a chest frontal view). Anatomical areas set in the anatomical model include a thoracic area that includes a lung field and a mediastinum both important in making diagnosis with respect to the chest frontal view, and bones that form the thoracic area.

The priority information 122b is information that associates the terms showing names of the basic body parts that indicate anatomical sections in the chest area, which are listed in the location correspondence information 122a, with respective numerical values showing priorities (also referred to as priority degrees). The priority information 122b is used by a body part designation unit 308, which is described later. For example, when a doctor designates an area, on a medical image, to which attention is to be paid (also referred to as an attention area), and a plurality of terms concerning basic body parts are identified as terms that correspond to the attention area, a term concerning a basic body part having a high priority degree is designated preferentially in accordance with the priority degrees.

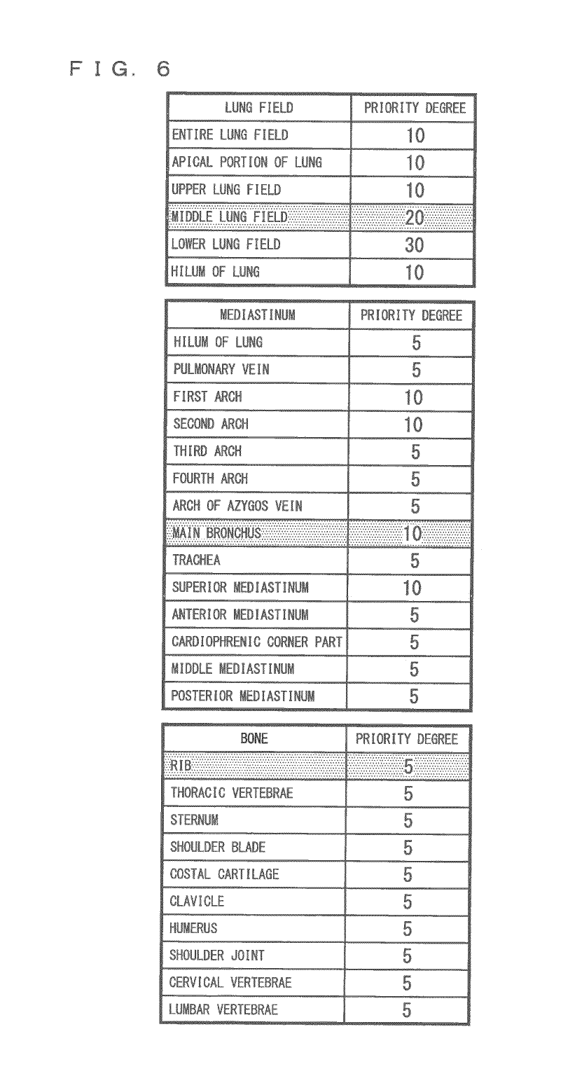

FIG. 6 shows an example of contents of the priority information 122b. As shown in FIG. 6, the terms showing names of the basic body parts that indicate anatomical sections of the chest area are associated with respective numerical values showing priorities.

The term information 122c is information that includes, with respect to a finding sentence and attribute information concerning the finding sentence each included in a diagnostic result report, a list of one or more terms as one or more elements, that can be used as one or more term for a corresponding one of items, by an item. In the present embodiment, the term information 122c is in the form of a table.

When a finding sentence included in a radiologic interpretation report is taken as an example, the items include items concerning the attribute information, such as “examined body part” and “shooting condition”, and a plurality of items concerning a current state of a patient, such as “basic body part”, “basic findings”, and “diagnosis”. That is to say, in the present embodiment, the plurality of items include an item concerning a body part as a first item, an item concerning findings as a second item, and an item concerning diagnosis as a third item. This facilitates designation of elements concerning findings and diagnosis in creating the diagnostic result report. A term includes a symbol that represents the term.

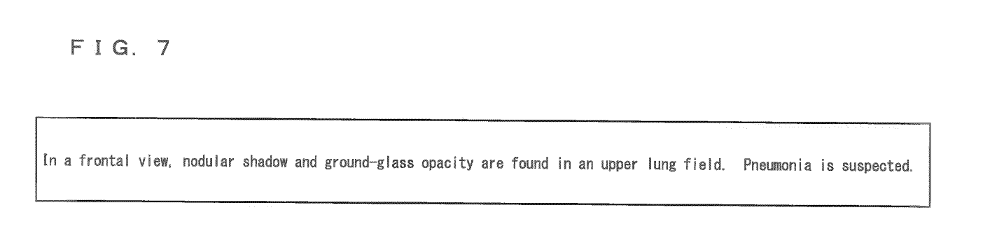

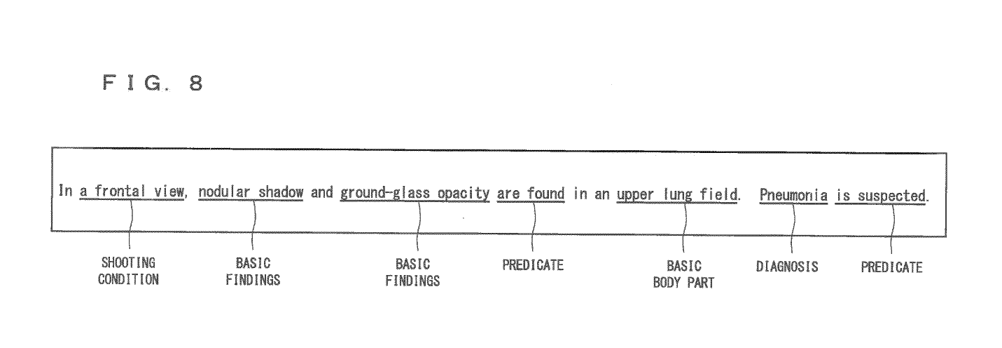

FIG. 7 shows examples of a finding sentence. FIG. 8 is a diagram for describing the structure of the finding sentences shown in FIG. 7. As shown in FIG. 8, the finding sentences shown in FIG. 7 are composed of terms that belong to four main items (a shooting condition, a basic body part, basic findings, diagnosis) and the other words and phrases (e.g., a preposition and a predicate). Specifically, the finding sentences shown in FIG. 7 are composed of a term “frontal view” that belongs to the item “shooting condition”, a term “upper lung field” that belongs to the item “basic body part”, terms “nodular shadow” and “ground-glass opacity” that belong to the item “basic findings”, a term “pneumonia” that belongs to the item “diagnosis”, and the other words and phrases.

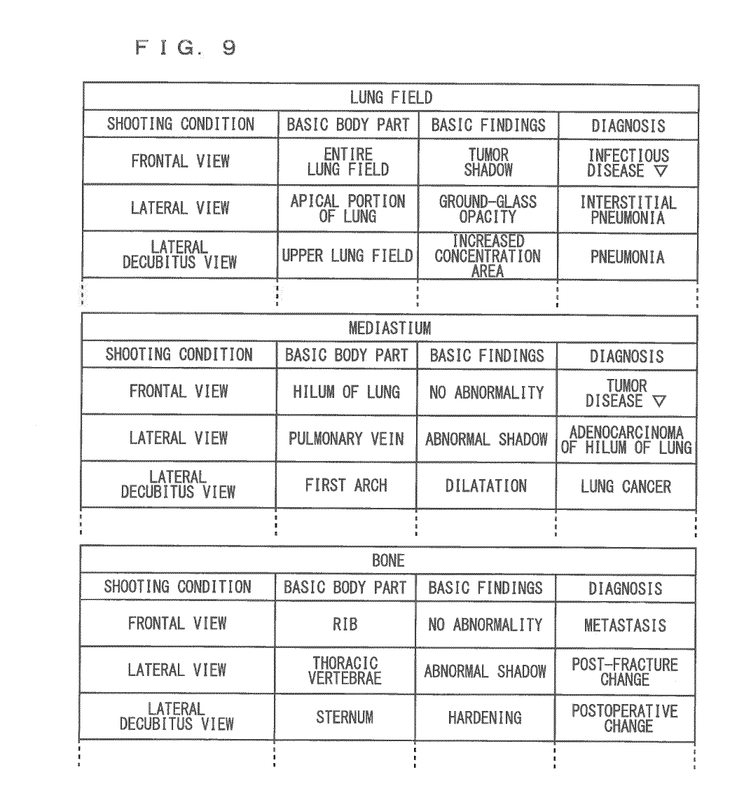

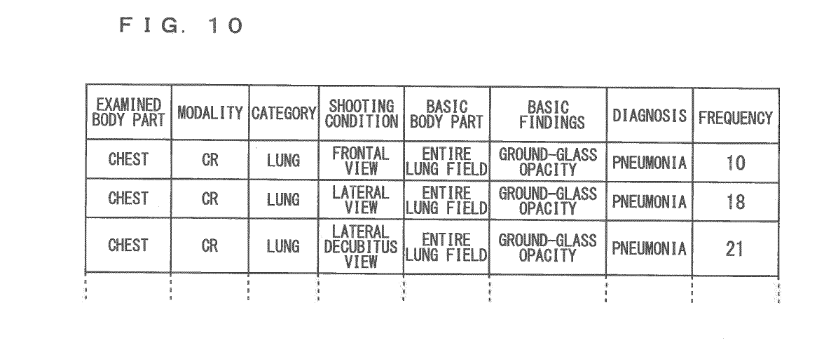

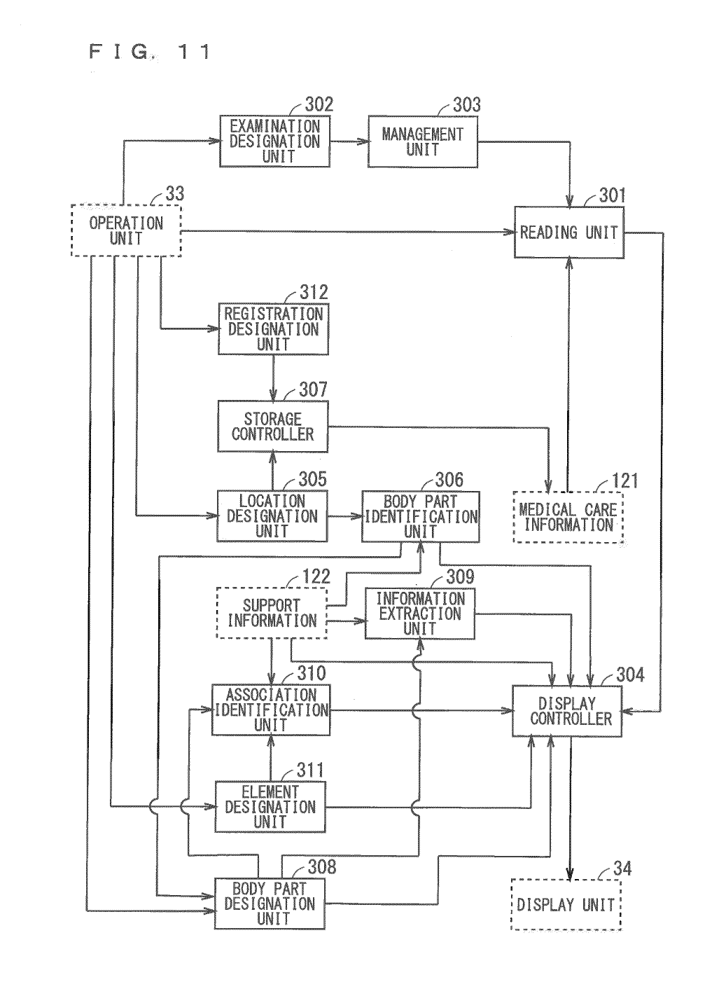

FIG. 9 shows an example of part of contents of the term information 122c. As shown in FIG. 9, in the term information 122c, a plurality of terms that belong to the four items (a shooting condition, a basic body part, basic findings, diagnosis) are listed for each category (a lung field, a mediastinum, and a bone in this example), for example. That is to say, in the term information 122c, a plurality of terms belong to each of a plurality of items that include an item concerning basic body part, that indicate a body part in the three-dimensional anatomy, as the first item, and an item concerning basic findings as the second item and an item concerning diagnosis as the third item, which are different from the first item.

For example, as for the category “lung field”, a plurality of terms (a frontal view, a lateral view, and a lateral decubitus view) are listed for the item “shooting condition”, and a plurality of terms (e.g., an entire lung field, an apical portion of a lung, and an upper lung field) are listed for the item “basic body part”. In addition, a plurality of terms (e.g., tumor shadow, ground-glass opacity, and an increased concentration area) are listed for the item “basic findings”, and a plurality of terms (e.g., interstitial pneumonia and pneumonia) concerning each of classes of a disease (e.g., an infectious disease) are listed for the item “diagnosis”, for example.

The combination frequency information 122d is information that indicates frequency of combination of terms used in diagnostic result reports including finding sentences. In the present embodiment, the combination frequency information 122d is in the form of a table. As the frequency, the number of combination times of terms used in many past diagnostic result reports are combined can be used, for example. That is to say, in the combination frequency information 122d, a plurality of terms belong to each of a plurality of items that include the item concerning a body part in the three-dimensional anatomy, which is the first item, the item concerning basic findings, which is the second item, and the item concerning diagnosis, which is the third item. The combination frequency information 122d as a combination information group indicates a plurality of combinations of terms that belong to a plurality of items.

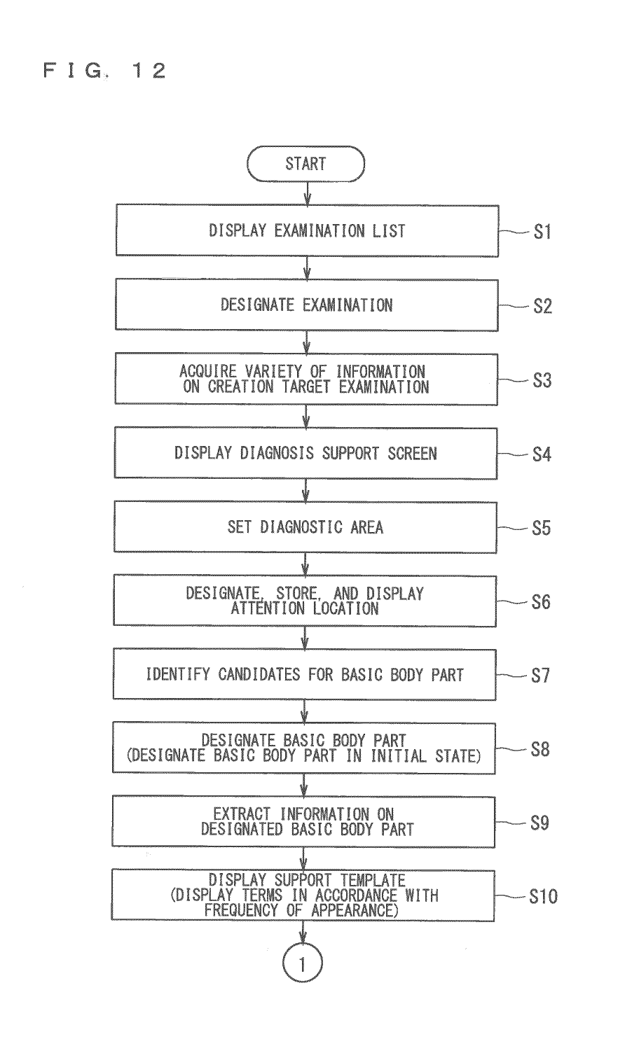

FIG. 10 shows an example of part of contents of the combination frequency information 122d. For example, as shown in FIG. 10, the number of combination times regarding terms used in many past diagnostic result reports are listed for each combination of terms, counting a combination of terms used in a single past diagnostic result report as one combination of terms. That is to say, the combination frequency information 122d, which is the combination information group, includes information indicating a plurality of combinations of terms (also referred to as combination information).

In the present embodiment, the term information 122c and the combination frequency information 122d are stored such that combinations of terms can be distinguished from one another by a combination of a term concerning an examined body part (e.g., CHEST and HEAD) and a term concerning a modality (e.g., CR and US).

The term information 122c and the combination frequency information 122d as described above can be created from information obtained by structuring many diagnostic result reports with use of a resource description framework (RDF) and an extensible markup language (XML), for example. For example, structuring with use of the resource description framework (RDF) is achieved by extracting, as for each diagnostic result report, a necessary element from a finding sentence that is a natural sentence and extracting various elements from the attribute information. As a result, as for many diagnostic result reports, data on many structured diagnostic result reports (also referred to as structured report data) is generated. In the present embodiment, an element extracted from a finding sentence and the attribute information is a term. A term includes a symbol that represents the term.

Specifically, information on a diagnostic result report is structured by dividing a variety of information included in report data and the attribute information into terms that belong to respective items and describing the terms with use of the RDF based on model data obtained through machine learning, for example. The model data is herein data of a model that indicates how elements constituting an existing radiologic interpretation report are divided into elements that belong to respective items. The items include an item concerning the attribute information (e.g., an examined body part and a shooting condition) and a plurality of items concerning a current state of a patient (e.g., a basic body part, basic findings, and diagnosis).

For example, the finding sentences shown in FIG. 7 are divided into terms that belong to respective items as shown in FIG. 8. Specifically, the term “frontal view” is identified as a term that belongs to the item “shooting condition”, the term “upper lung field” is identified as a term that belongs to the item “basic body part”, the terms “nodular shadow” and “ground-glass opacity” are identified as terms that belong to the item “basic findings”, and the term “pneumonia” is identified as a term that belongs to the item “diagnosis”.

If there are too many synonyms (e.g., terms “T2-weighted image” and “T2WI”) when the term information 122c and the combination frequency information 122d are built up, the number of terms increases excessively. With respect to synonyms, processing to replace each of the synonyms with a single representative term may be performed, for example. Replacement with the representative term can be achieved by including, in information used in machine learning, a table in which a plurality of terms are associated with a representative term, for example.

In a diagnostic result report, a term such as a modifier can be added to each of terms that belong to respective items, for example. For example, a term “circular nodular shadow” is a complex of a term “nodular shadow” that belongs to the item “basic findings” and a term “circular” as a modifier. In this case, a term that belongs to a detailed item “modifier” (hereinafter also referred to as a detailed element) may be identified from a finding sentence that is a natural sentence, and structured report data may be generated such that the detailed element is included. The term information 122c and the combination frequency information 122d may also be generated such that the detailed element is included.

The number of diagnostic result reports stored in the medical care information 121 can increase each time a new diagnostic result report is generated in response to input from the terminal device 30. Use of the diagnostic result reports stored over time as knowledge from the past is effective. Therefore, reflecting a term and a combination of terms included in a newly generated diagnostic result report in the term information 122c and the combination frequency information 122d is also effective. A newly stored diagnostic result report that includes a new finding sentence is especially valuable as the knowledge from the past is further developed.

The communication unit 15 performs data transmission/reception with a device other than the server 10 via the communication line W1, for example.

### <(2-2) Terminal Device>

The controller 31 includes a processor 31a, such as a central processing unit (CPU), and volatile memory 31b, such as random access memory (RAM), for example. The processor 31a achieves the diagnosis support processing by reading a program 321 stored in the storage 32 and performing a variety of processing in accordance with the program 321. That is to say, functions of the information processing system 1 to perform the diagnosis support processing are achieved by the processor 31a executing the program 321.

The storage 32 includes non-volatile semiconductor memory or a hard disk, for example, and stores therein the program 321 and a variety of data. The variety of data can include data that indicates a parameter and the like that are required to perform processing in accordance with the program 321 and data that is at least temporarily generated as a result of arithmetic processing.

The operation unit 33 includes a pointing device, such as a keyboard and a mouse, for example. The operation unit 33 outputs, to the controller 31, a signal (also referred to as an instruction signal) that is generated in accordance with an operation performed on the keyboard, the mouse, and the like. The operation unit 33 may be in the form of a touch panel, or the like.

The display unit 34 includes various display devices, such as a liquid crystal display (LCD), for example. The display unit 34 visually outputs a variety of information in response to a signal input from the controller 31.

The communication unit 35 performs data transmission/reception with a device other than the terminal device 30 via the communication line W1 and the like.

### <(3) Functional Components for Implementing Diagnosis Support Processing>

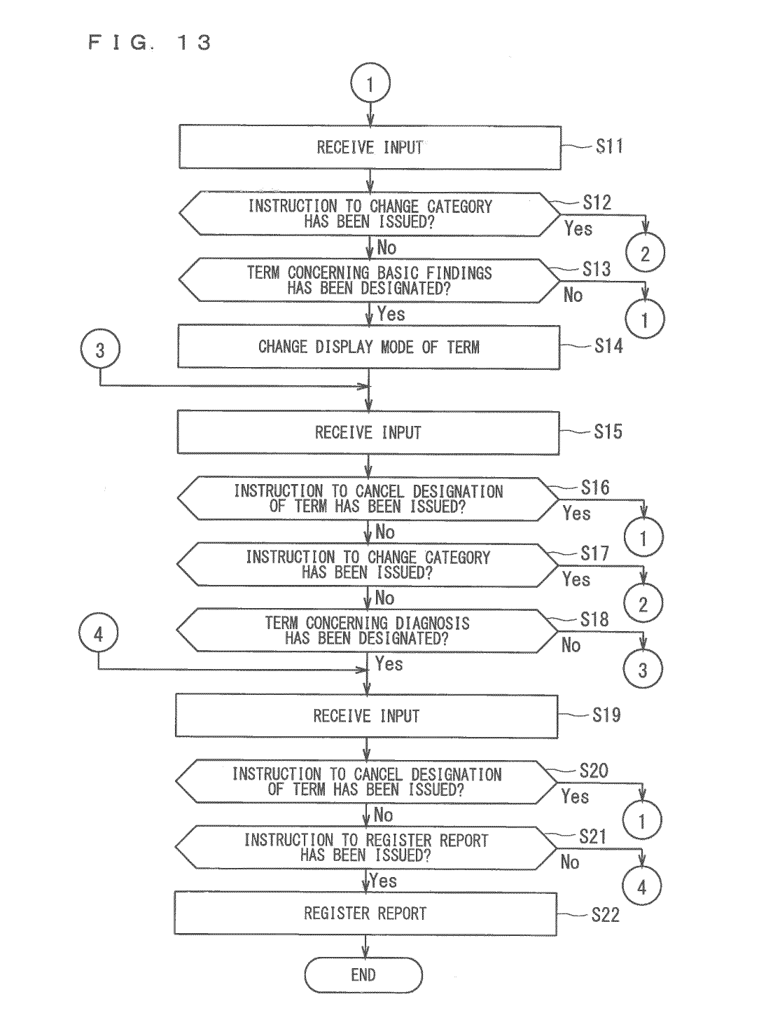

FIG. 11 is a block diagram showing functional components for implementing the diagnosis support processing.

The information processing system 1 includes a plurality of functional components for achieving the diagnosis support processing in the controllers 11 and 31, for example. The plurality of functional components include a reading unit 301, an examination designation unit 302, a management unit 303, a display controller 304, a location designation unit 305, a body part identification unit 306, a storage controller 307, a body part designation unit 308, an information extraction unit 309, an association identification unit 310, an element designation unit 311, and a registration designation unit 312.

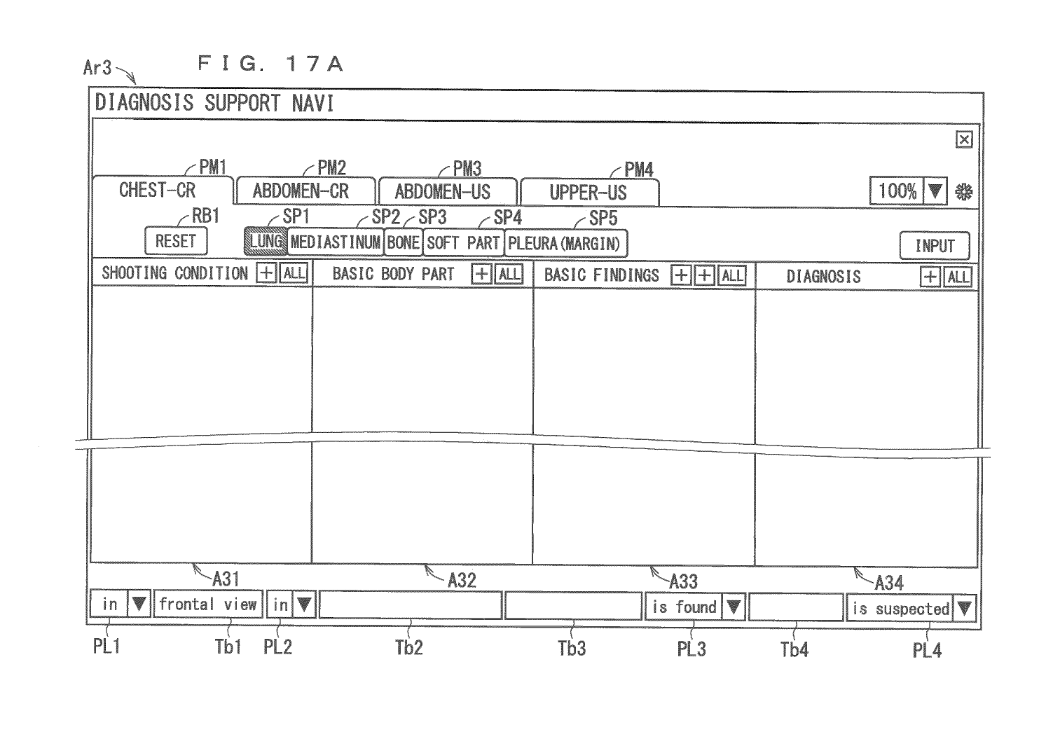

The reading unit 301 reads a variety of information from the medical care information 121 in response to a signal from the operation unit 33 and a command from the management unit 303. The variety of read information includes information on the examination list 121b and a variety of data on an examination targeted for creation of a diagnostic result report (also referred to as a creation target examination), for example. The variety of information read by the reading unit 301 is visually output by the display unit 34 as appropriate through control performed by the display controller 304. As a result, an examination list screen DL1 (FIG. 15), which is described later, is displayed by the display unit 34, and data on a medical image regarding the creation target examination is visually output by the display unit 34, for example.

The examination designation unit 302 designates a creation target examination in response to a signal from the operation unit 33.

The management unit 303 specifies a task of creating a diagnostic result report corresponding to the creation target examination designated by the examination designation unit 302, and causes the reading unit 301 to read a variety of information on the creation target examination from the medical care information 121. The variety of read information includes the data on the medical image regarding the creation target examination and basic information regarding the creation target examination, for example.

The display controller 304 controls visual output of a variety of information performed by the display unit 34. The display controller 304 causes the display unit 34 to display the examination list screen DL1 (FIG. 15) based on the information on the examination list 121b read by the reading unit 301 from the medical care information 121, for example. The display controller 304 also causes the display unit 34 to display a medical image based on the data on the medical image regarding the creation target examination read by the reading unit 301 in response to designation of the creation target examination by the examination designation unit 302, for example.

The display controller 304 also causes the display unit 34 to display a list of terms (also referred to as a term list) as a plurality of options, based on information on at least one or more combinations of terms indicated by the combination frequency information 122d, which is the combination information group. The term list includes a first part concerning the first item, a second part concerning the second item, and a third part concerning the third item, for example. The first part is a part in which terms belonging to an item “basic body part”, which is the first item, are listed for a name of the first item. The second part is a part in which terms belonging to an item “basic findings”, which is the second item, are listed for a name of the second item. The third part is a part in which terms belonging to an item “diagnosis”, which is the third item, are listed for a name of the third item. The information on at least one or more combinations of terms indicated by the combination frequency information 122d can be extracted by the information extraction unit 309 as appropriate.

The location designation unit 305 designates, in accordance with a user operation on the operation unit 33, an attention location on a medical image displayed by the display unit 34. An example of the attention location is a location, on a medical image, at which a doctor has found an abnormal shadow and the like. Designation of the attention location may be achieved, for example, by setting a mouse pointer at a given location on the medical image, and double clicking a left mouse button by pressing the left mouse button twice in succession.

The body part identification unit 306 performs processing (also referred to as body part identification processing) to identify, from among terms that belong to the “basic body part”, which is the first item, two or more terms that correspond to the attention location designated by the location designation unit 305 as candidates for a term concerning the item “basic body part”. In the body part identification processing, information (also referred to as location information) indicating the attention location on the medical image is converted into information on a location in the anatomical model, and two or more terms that belong to the item “basic body part”, which is the first item, and are associated with the information on the location in the anatomical model are extracted from the location correspondence information 122a. This facilitates identification of a body part according to the three-dimensional anatomy.

Since subjects captured in a two-dimensional medical image are three-dimensional anatomical components, two or more body parts can exist in a depth direction of the medical image at the attention location designated on the two-dimensional medical image. In the present embodiment, two or more terms that show names of basic body parts and correspond to the designated attention location are identified as candidates for a term concerning the item “basic body part”.

The storage controller 307 causes the storage 12 to store therein the location information on the attention location, in the medical image, designated by the location designation unit 305. In this case, the location information is stored within the information on the creation target examination included in the medical care information 121 stored in the storage 12, for example. Examples of the location information are an address and coordinates that specify a pixel of the medical image.

At the same time, the display controller 304 causes the display unit 34 to display the attention location on the medical image based on the location information on the attention location, in the medical image, stored in the storage 12 so that the attention location is distinguishable from a surrounding area. For example, the attention location may be indicated by use of a preset marker. Examples of the marker are a frame enclosing the attention location and an arrow pointing to the attention location. By thus displaying the attention location on the medical image so that the attention location is distinguishable, the attention location can easily be referred to. As a result, diagnostic result reports can properly be created.

The body part designation unit 308 designates, in accordance with a user operation on the operation unit 33, one of the two or more terms identified, as the candidates for the term, by the body part identification unit 306.

The information extraction unit 309 extracts information that corresponds to the one term that is designated by the body part designation unit 308 and belongs to the item “basic body part” from the combination frequency information 122d, which is the combination information group, stored in the support information 122.

The association identification unit 310 identifies, in response to designation of the one term by the body part designation unit 308, one or more combinations of terms that are indicated by the combination frequency information 122d and correspond to the one term designated by the body part designation unit 308. In this case, the display controller 304 causes the display unit 34 to display one or more terms that are included in the one or more combinations of terms identified by the association identification unit 310 and belong to the second item “basic findings” based on the one or more combinations of terms so that the one or more terms are distinguishable from the other terms, for example.

Specifically, the display controller 304 causes the display unit 34 to display, in the term list, the one or more terms that are included in the one or more combinations of terms identified by the association identification unit 310 and belong to the second item “basic findings” so that the one or more terms are distinguishable from one or more remaining terms that belong to the second item “basic findings”, for example. The one or more terms that belong to the item “basic findings” and are associated with the designated term that belongs to the item “basic body part” can thus easily be known. As a result, designation of terms in creating a diagnostic result report is further facilitated.

Furthermore, the display controller 304 may cause the display unit 34 to display, in the term list, one or more terms that belong to the second item “basic findings” and are included in the one or more combinations of terms identified by the association identification unit 310 in accordance with frequency of appearance in the one or more combinations of terms, for example. An example of the frequency of appearance is frequency regarding one or more combinations of terms that are indicated by the combination frequency information 122d and correspond to the one term that is designated by the body part designation unit 308. The one or more terms that belong to the item “basic findings” and are strongly associated with the designated term that belongs to the item “basic body part” can thus easily be known. As a result, designation of terms in creating a diagnostic result report is further facilitated.

The element designation unit 311 designates, in accordance with a user operation on the operation unit 33, one or more of two or more terms that belong to the second item “basic findings” and are displayed by the display unit 34. The element designation unit 311 also designates, in accordance with a user operation on the operation unit 33, one or more of two or more terms that belong to the third item “diagnosis” and are displayed by the display unit 34.

In response to designation of the one or more terms by the element designation unit 311, the association identification unit 310 identifies at least one combination of terms that is indicated by the combination frequency information 122d and corresponds to a combination of the one term designated by the body part designation unit 308 and each of the one or more terms designated by the element designation unit 311. In this case, the display controller 304 causes the display unit 34 to display, in the term list, one or more terms that are included in the at least one combination of terms identified by the association identification unit 310 and belong to the third item “diagnosis” based on the at least one combination of terms so that the one or more terms are distinguishable from the other terms, for example.

Specifically, the display controller 304 causes the display unit 34 to display, in the term list, the one or more terms that are included in the at least one combination of terms identified by the association identification unit 310 and belong to the third item “diagnosis” so that the one or more terms are distinguishable from one or more remaining terms that belong to the third item “diagnosis”, for example. The one or more terms that belong to the item “diagnosis” and are associated with a combination of the designated term that belongs to the item “basic body part” and the designated term that belongs to the item “basic findings” can thus easily be known. As a result, designation of terms in creating a diagnostic result report is further facilitated.

Furthermore, the display controller 304 may cause the display unit 34 to display, in the term list, one or more terms that belong to the third item “diagnosis” and are included in the at least one combination of terms identified by the association identification unit 310 in accordance with frequency of appearance in the at least one combination of terms, for example. An example of the frequency of appearance is frequency regarding at least one combination of terms that is indicated by the combination frequency information 122d and corresponds to a combination of the one term that is designated by the body part designation unit 308 and each of the one or more terms designated by the element designation unit 311. The one or more terms that belong to the item “diagnosis” and are strongly associated with a combination of the designated term that belongs to the item “basic body part” and the designated term that belongs to the item “basic findings” can thus easily be known. As a result, designation of terms in creating a diagnostic result report is further facilitated.

Each term may be displayed so as to be distinguishable in accordance with frequency of appearance of the term, for example, by changing density, a color, a size, thickness, brightness, and a font of the term, and by changing density, a color, and brightness of a frame enclosing the term, for example. Alternatively, the term may be displayed so as to be distinguishable in accordance with frequency of appearance of the term, for example, by linking terms that belong to different items to each other by use of various display elements, such as a line and an arrow, in accordance with the combination information. The term may be displayed in accordance with frequency of appearance of the term, for example, by changing a method for displaying the term when the frequency of appearance of the term falls within a preset value range. The one or more terms that belong to the item “diagnosis” and are strongly associated with a combination of the designated term that belongs to the item “basic body part” and the designated term that belongs to the item “basic findings” can thus easily be known. As a result, designation of terms in creating a diagnostic result report is further facilitated.

The registration designation unit 312 designates registration of a diagnostic result report in accordance with a user operation on the operation unit 33. In this case, the storage controller 307 causes the storage 12 to store therein a diagnostic result report including a finding sentence that is created based on one term concerning the item “basic body part” designated by the body part designation unit 308, and two or more terms concerning the items “basic findings” and “diagnosis” designated by the element designation unit 311, for example. Data on a diagnostic result report can be stored in the storage 12 as information on the creation target examination included in the medical care information 121, for example.

### <(4) Operation Flow of and Screen Transition in Diagnosis Support Processing>

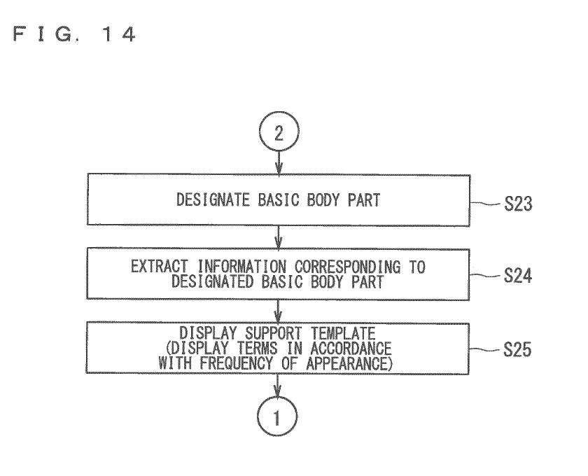

FIGS. 12-14 are flow charts showing an example of an operation flow of the diagnosis support processing performed by the information processing system 1. The operation flow is achieved by cooperation between the controller 11 that executes the program 123 and the controller 31 that executes the program 321, for example. Description is made below by taking, as an example, a case where the medical care information 121 and the support information 122 are stored in advance in the storage 12, and a doctor as a user creates a diagnostic result report for an examination for which the diagnostic result report has not been created. Processing in steps S1-S25 is performed with the start of the diagnosis support processing in accordance with a user operation on the operation unit 33.

In step S1, the reading unit 301 reads information on the examination list 121b included in the medical care information 121, and the display controller 304 causes the display unit 34 to display the examination list screen DL1 (FIG. 15) based on the information on the examination list 121b. The examination list screen DL1 is a screen for designating a creation target examination, which is an examination targeted for creation of a diagnostic result report. As shown in FIG. 15, the examination list screen DL1 includes a list of information pieces on an examination (specifically, a patient ID, a patient name, a birth date, age, sex, a state, an examination ID, an examination date, an examined body part, a modality, the number of images, and the like) for a plurality of examinations. In the examination list screen DL1, an examination that is indicated by a state “not created” corresponds to an examination for which a diagnostic result report has not been created, and a solid frame CS1 for designating the creation target examination is moved up and down in accordance with a doctor's operation on the operation unit 33.

In step S2, when a doctor presses a set button (e.g., an enter key) on the operation unit 33 in a state in which the solid frame CS1 is set to a desired examination in the examination list screen DL1, the examination designation unit 302 designates the examination enclosed by the solid frame CS1 as a creation target examination. In this case, the management unit 303 specifies a task of creating a diagnostic result report corresponding to the creation target examination designated by the examination designation unit 302.

In step S3, the reading unit 301 reads a variety of information on the creation target examination from the medical care information 121. The variety of information read herein includes data on the medical image regarding the creation target examination and basic information regarding the creation target examination, for example.

In step S4, the display controller 304 causes the display unit 34 to display the diagnosis support screen SD1 (FIGS. 16-18) including the medical image based on the data on the medical image regarding the creation target examination and the basic information regarding the creation target examination as acquired in step S3. The diagnosis support screen SD1 is a screen for supporting creation of a diagnostic result report by a doctor.

The following describes the diagnosis support screen SD1 with reference to FIGS. 16-18.

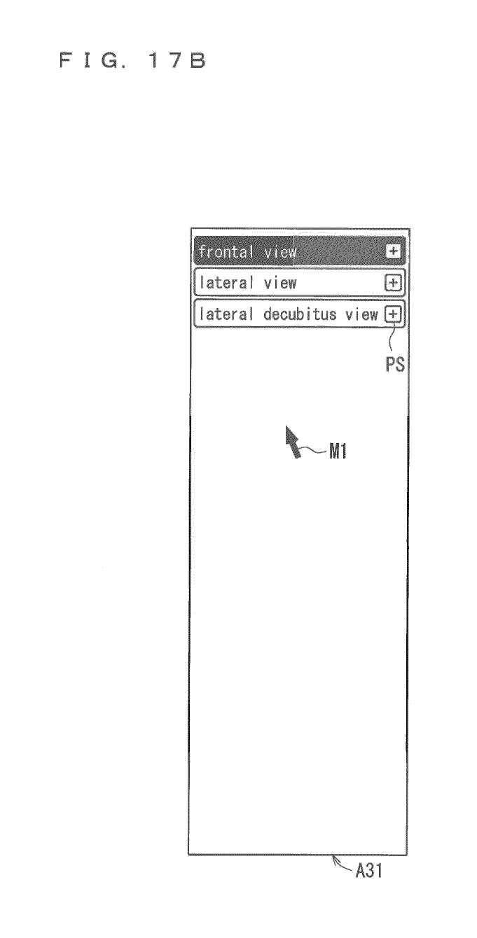

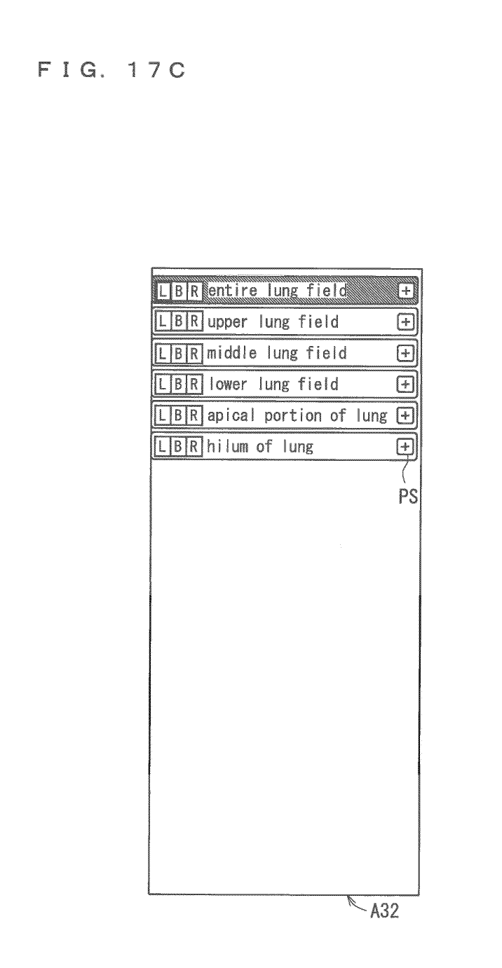

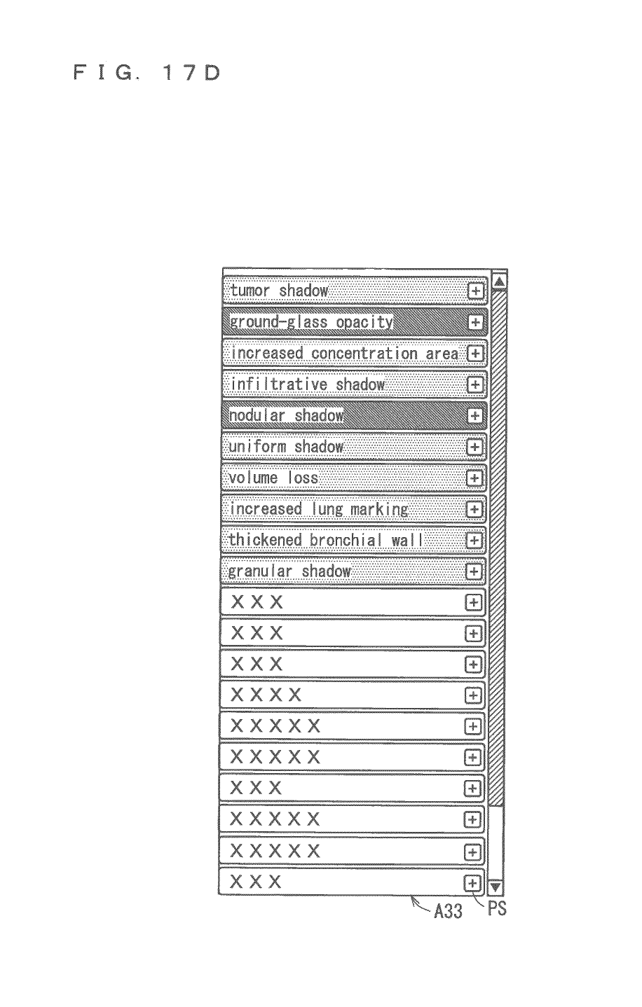

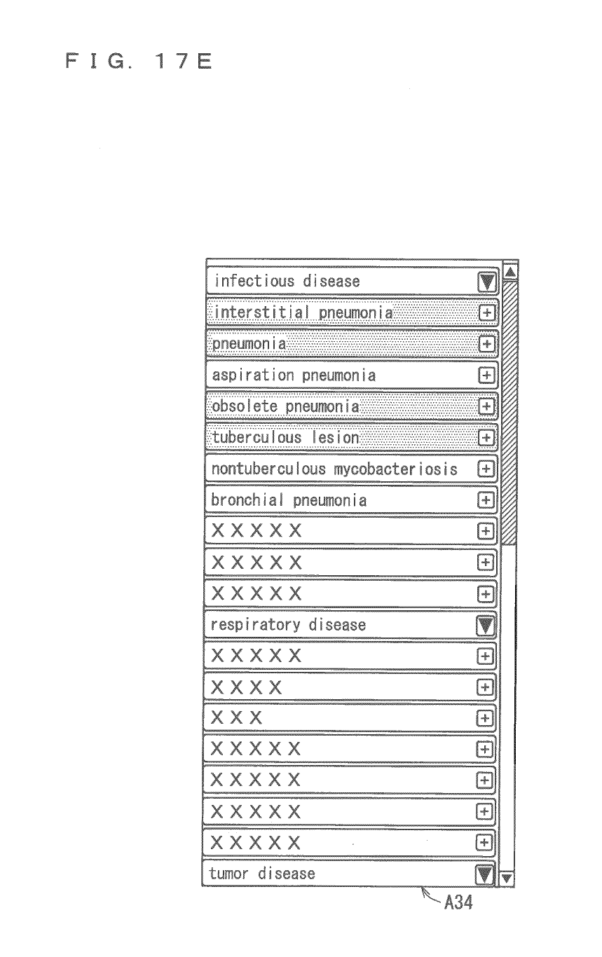

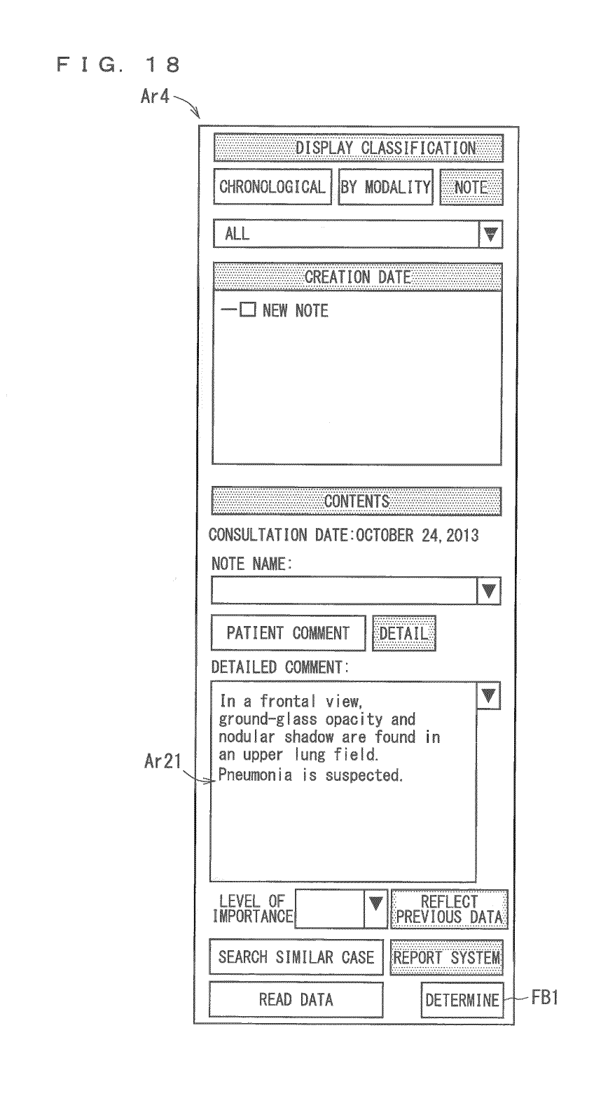

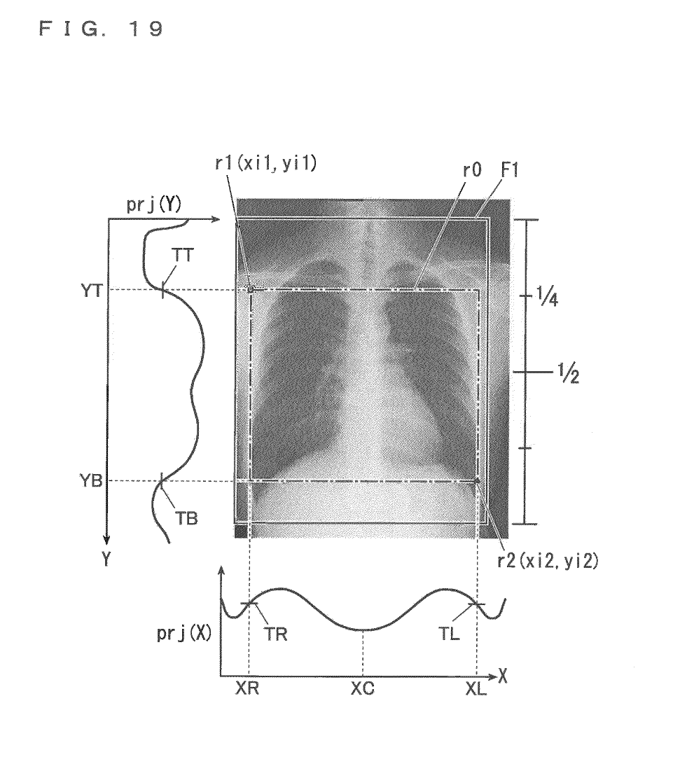

As shown in FIG. 16, the diagnosis support screen SD1 is mainly composed of first to fourth areas Ar1-Ar4. In the first area Ar1, various buttons used for switching of a display screen are displayed. In the second area Ar2, a medical image regarding the creation target examination is displayed. In the third area Ar3, a template for supporting input of a diagnostic result report (also referred to as a support template) is displayed. In the fourth area Ar4, contents of a record regarding the creation target examination are displayed. FIGS. 17A to 17E show an example of the support template displayed in the third area Ar3. FIG. 18 shows an example of contents of a display in the fourth area Ar4.

The display controller 304 causes the display unit 34 to display the support template as a template that includes a list of terms (a term list) as a plurality of options, based on information on at least one or more combinations of terms indicated by the combination frequency information 122d, which is the combination information group. In the present embodiment, the information on the at least one or more combinations of terms is information on one or more combinations of terms that are indicated by the combination frequency information 122d, which is the combination information group, and correspond to a combination of an examined body part and a modality regarding the creation target examination.

FIGS. 17A to 17E show an example of the support template that corresponds to a combination of an examined body part “CHEST” and a modality “CR”. In the support template, display elements PM1-PM4 that indicate respective combinations of an examined body part and a modality regarding the creation target examination are displayed in an upper part, for example. Below the display elements PM1-PM4, a reset button RB1, category buttons SP1-SP5, and the like are displayed. In a middle part, selection areas A31-A34 are displayed. In a lower part, text boxes Tb1-Tb4 and predicate lists PL1-PL4 are displayed. In the support template, pressing of various buttons and appearance of a cursor are achieved by a mouse pointer M1 that works in accordance with a doctor's operation on the operation unit 33, for example.

The category buttons SP1-SP5 are buttons for selectively designating one or more terms that belong to a category regarding the diagnostic result report as an input target. By identifying one or more terms that belong to a category that correspond to an examined body part and a modality regarding the creation target examination from the term information 122c, the buttons for selectively designating the one or more terms are shown. In the support template shown in FIGS. 17A to 17E, by selectively pressing any one of the five category buttons SP1-SP5 with the mouse pointer M1, one or more terms that belong to the category concerning the diagnostic result report as the input target are selectively designated. In the present embodiment, from among the category buttons SP1-SP5, a category button that is currently designated is highlighted, and category buttons that cannot be designated are displayed as a translucent button, for example. In the present embodiment, from among terms included in the term information 122c, one or more terms that correspond to a combination of terms concerning the examined body part and the modality regarding the creation target examination and a term that belong to a category designated by any of the category buttons SP1-SP5 can be listed, for each item, in the selection areas A31-A34.

The selection areas A31-A34 are large areas that occupy the middle part of the support template, and are sequentially arranged from left to right in the stated order, for example. Specifically, in the selection area A31, a plurality of options for a term that belongs to the item “shooting condition” (e.g., a frontal view, a lateral view, and a lateral decubitus view) are listed downwards, for example. In the selection area A32 as the first part, a plurality of options for a term that belongs to the item “basic body part” (e.g., an entire lung field, an upper lung field, and a middle lung field) are listed downwards. In the selection area A33 as the second part, a plurality of options for a term that belongs to the item “basic findings” (e.g., tumor shadow, ground-glass opacity, and an increased concentration area) are listed downwards. In the selection area A34 as the third part, a plurality of classes that belong to the item “diagnosis” (e.g., an infectious disease, a respiratory disease, and a tumor disease) are listed downwards, and, for each of the classes, a plurality of options for a term (e.g., interstitial pneumonia, pneumonia, and aspiration pneumonia) are listed downwards. That is to say, in the selection areas A31-A34, a plurality of options for the terms that belong to the items “shooting condition”, “basic body part”, “basic findings”, and “diagnosis” are presented so as to be distinguishable by an item. In the selection areas A31-A34, terms that belong to the category regarding one of the category buttons SP1-SP5 that is currently designated are listed. In the present embodiment, some of the terms are shown as “XXXX”, for example, to avoid complexity of the drawing.

In the selection area A31, when a desired option for the term is pressed with the mouse pointer M1 in accordance with a doctor's operation on the operation unit 33, the desired option for the term is designated for the item “shooting condition”. In this case, the designated option for the term is shown so as to be distinguishable from the other options (e.g., highlighted), and the designated term is displayed in the text box Tbl as a term that belongs to the item “shooting condition”. The term that belongs to the item “shooting condition” can appropriately be designated in the selection area A31 while a doctor checks the medical image displayed in the second area Ar2. In the present embodiment, however, a term indicating a shooting condition is provided in advance to the data on the medical image regarding the creation target examination, and, upon determination of the medical image displayed in the second area Ar2, the term indicating the shooting condition provided to the medical image is designated automatically in the selection area A31.

In the selection area A32, a desired option for the term is designated for the item “basic body part” in accordance with a doctor's operation on the operation unit 33. In this case, the designated option for the term is shown so as to be distinguishable from the other options (e.g., highlighted), and the designated term is displayed in the text box Tb2 as a term that belongs to the item “basic body part”. As for designation of the term that belongs to the item “basic body part”, upon designation of the attention location on the medical image displayed in the second area Ar2, candidates for the term that belongs to the item “basic body part” are automatically identified through the body part identification processing, which is described later, for example. Options for the term that belongs to the item “basic body part” are thus narrowed down, and designation of the term that belongs to the item “basic body part” is facilitated. By pressing, with the mouse pointer M1, any of buttons “L”, “B”, “R” provided on the left side of the designated option for the term, a modifier “left”, “both”, or “right” may be added to the term displayed in the text box Tb2 as appropriate.

In the selection area A33, when a desired option for the term is pressed with the mouse pointer M1 in accordance with a doctor's operation on the operation unit 33, the desired option for the term is designated for the item “basic findings”. In this case, the designated option for the term is shown so as to be distinguishable from the other options (e.g., highlighted), and the designated term is displayed in the text box Tb3 as a term that belongs to the item “basic findings”.

In the selection area A34, when a desired option for the term is pressed with the mouse pointer M1 in accordance with a doctor's operation on the operation unit 33, the desired option for the term is designated for the item “diagnosis”. In this case, the designated option for the term is shown so as to be distinguishable from the other options (e.g., highlighted), and the designated term is displayed in the text box Tb4 as a term that belongs to the item “diagnosis”.

In the selection areas A31-A34, a detail designate button PS is provided on the right side of each option for the term. When the detail designate button PS is pressed with the mouse pointer M1, a window (also referred to as a detail window) OW1 in which a detailed element that modifies the designated term can be input is displayed so as to be overlaid on the support template. The detailed element includes a term such as a modifier, for example.

Use of such a support template allows doctors to designate an option for a term in each of the selection areas A31-A34 while referring to a medical image regarding the creation target examination displayed in the second area Ar2 of the diagnosis support screen SD1, thereby facilitating creation of finding sentences. For example, when terms “frontal view”, “entire lung field”, “ground-glass opacity”, and “pneumonia” are designated for respective four items (a shooting condition, a basic body part, basic findings, and diagnosis), finding sentences “In a frontal view, ground-glass opacity is found in the entire lung field. Pneumonia is suspected.” can be created, for example. For a specific item (e.g., basic findings), two or more options for the term may be designated to create a finding sentence. Specifically, when terms “frontal view”, “entire lung field”, “ground-glass opacity”, “nodular shadow”, and “pneumonia” are designated for four items (a shooting condition, a basic body part, basic findings, and diagnosis), finding sentences “In a frontal view, ground-glass opacity and nodular shadow are found in the entire lung field. Pneumonia is suspected.” can be created, for example.

When doctors make diagnosis with reference a chest frontal view acquired by a CR device, the doctor typically checks whether there is an abnormal shadow in the order of “lung”, “mediastinum”, “bone”, “soft part”, and “pleura (margin)” in accordance with a display order of the category buttons SP1-SP5. When a three-dimensional anatomy is captured in a two-dimensional medical image, specialists may be able to specify the “basic body part” at which the abnormal shadow exists as they can imagine the three-dimensional anatomy from overlapping of shadows and the like, but general practitioners may have difficulty specifying the “basic body part” accurately. In the present embodiment, when a location, on a medical image, at which an abnormal shadow is found is designated by a doctor, candidates for the term that belongs to the item “basic body part” that can be included in the designated location are identified and presented. As a result, false identification and overlooking of a location at which an abnormality is found are less likely to occur in image diagnosis, and more reliable image diagnosis can be made.

In step S5, the body part identification unit 306 sets a diagnostic area r0 as an anatomical area targeted for diagnosis made with respect to a medical image displayed by the display unit 34 (also referred to as a diagnostic target).

The diagnostic area r0 is set at a location and in a range that cover an area that is required for making diagnosis with respect to the medical image regarding the creation target examination. In the present embodiment, a thoracic area that includes a lung field and a mediastinum, which are the most important areas in making diagnosis with respect to a chest frontal view as a medical image on the diagnosis support screen SD1 (FIG. 16), is set, as the diagnostic area r0 (FIG. 19), to the chest frontal view, for example.

FIG. 19 is a diagram for describing a method for setting the diagnostic area r0 in a medical image. The diagnostic area r0 can be set by the following method, for example. Assume, in this example, that an upper left point of the medical image is set to an origin, and a right-hand direction and a downward direction from the origin are respectively set to an X direction and a Y direction.

First, in an area corresponding to a radiation field F1 that is obtained by excluding an upper part and a lower part of the medical image, a relationship between an X coordinate and a cumulative value of density (also referred to as a cumulative density value) at each X coordinate are obtained as a profile prj (X) in the X direction. When the area corresponding to the radiation field F1 is divided into three equal parts in the X direction, an X coordinate corresponding to the minimum cumulative density value in a middle part of the area is set to an X coordinate of a midline (XC). Furthermore, when the area corresponding to the radiation field F1 is divided into three equal parts in the X direction, in a left part of the area, an X coordinate that corresponds to a cumulative density value that first becomes equal to a preset threshold TR in a direction toward a left end of the medical image in a part that is closer to the left end than an X coordinate corresponding to the local maximum cumulative value is set to a right end XR of the thoracic area. On the other hand, when the area corresponding to the radiation field F1 is divided into three equal parts in the X direction, in a right part of the area, an X coordinate that corresponds to a cumulative density value that first becomes equal to a preset threshold TL in a direction toward a right end of the medical image in a part that is closer to the right end than an X coordinate corresponding to the local maximum cumulative value is set to a left end XL of the thoracic area.

Next, in an area of the medical image that corresponds to the radiation field F1 between the right end XR and left end XL, a relationship between a Y coordinate and a cumulative value of density (also referred to as a cumulative density value) at each Y coordinate is obtained as a profile prj (Y) in the Y direction. When the area corresponding to the radiation field F1 is divided into four equal parts in the Y direction, in the highest part of the area, an Y coordinate that corresponds to a cumulative density value that first becomes equal to a preset threshold TT in a direction toward a top end of the medical image in a part that is closer to the top end than a Y coordinate corresponding to the maximum cumulative value is set to a top end YT of the thoracic area. On the other hand, when the area corresponding to the radiation field F1 is divided into four equal parts in the Y direction, in lower two parts (a lower half) of the area, a Y coordinate that corresponds to a cumulative density value that first becomes equal to a preset threshold TB in a direction toward a bottom end of the medical image is set to a bottom end YB of the thoracic area.

The thoracic area defined by the top end, the bottom end, the left end, and the right end thus obtained is set as the diagnostic area r0. Coordinates (xi1, yi1) of an upper left point r1 and coordinates (xi2, yi2) of a lower right point r2 of the diagnostic area r0 are also set.

As described above, the thoracic area extracted by the body part identification unit 306 is set as the diagnostic area r0 in the present embodiment. The present invention, however, is not limited to this structure. For example, a doctor as a user may manually designate any area in the medical image displayed by the display unit 34 as the diagnostic area r0 (thoracic area). The diagnostic area r0 is not limited to the thoracic area, and may optionally be set by a doctor as a user.

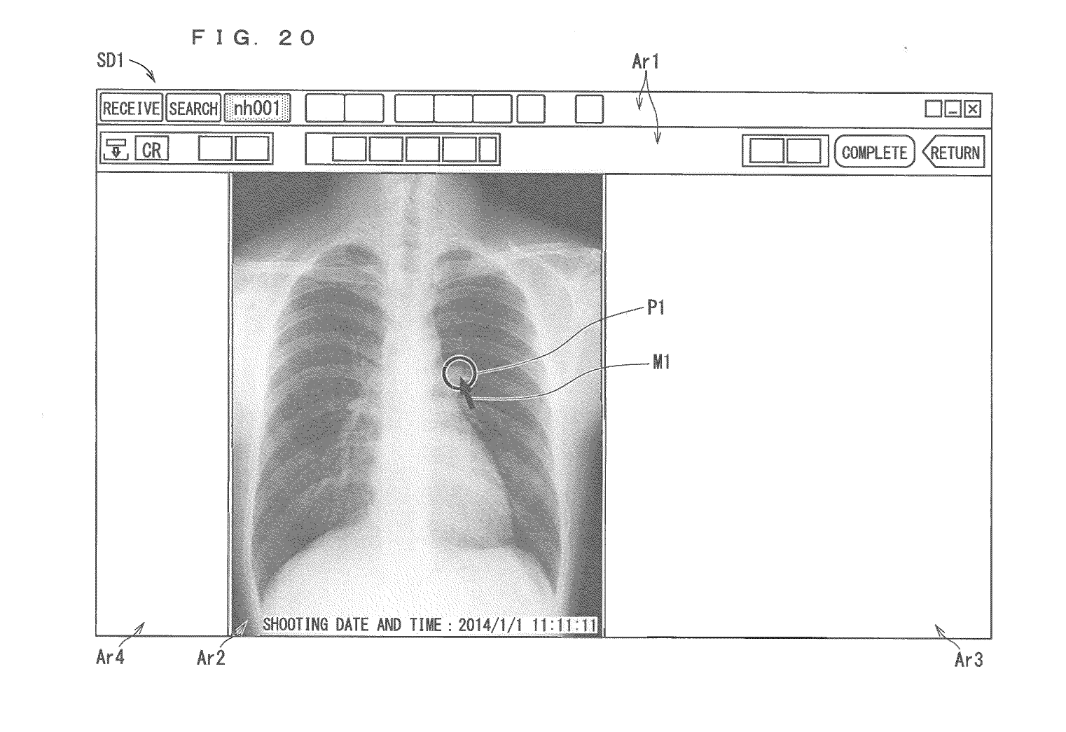

In step S6, the location designation unit 305 designates the attention location on the medical image in response to a doctor's operation on the operation unit 33. FIG. 20 shows an example of designation of the attention location on the medical image displayed in the second area Ar2 of the support template. In the present embodiment, the attention location is designated by setting the mouse pointer M1 at a desired location on the medical image, and double clicking a left mouse button by pressing the left mouse button twice in succession. In this case, the storage controller 307 causes the storage 12 to store therein location information that indicates the attention location on the medical image designated by the location designation unit 305. The display controller 304 causes the display unit 34 to display the attention location on the medical image based on the location information so that the attention location is distinguishable from a surrounding area. In FIG. 20, the attention location is enclosed by a circular frame P1 so as to be distinguishable from the surrounding area on the medical image.

In step S7, the body part identification unit 306 identifies candidates for a term concerning a basic body part that corresponds to the attention location designated in step S6. For example, first processing and second processing are performed herein. In the first processing, a location in the anatomical model that corresponds to the attention location designated in the medical image is obtained. In the second processing, two or more terms concerning a basic body part are identified as candidates for the term based on the location in the anatomical model obtained by the first processing.

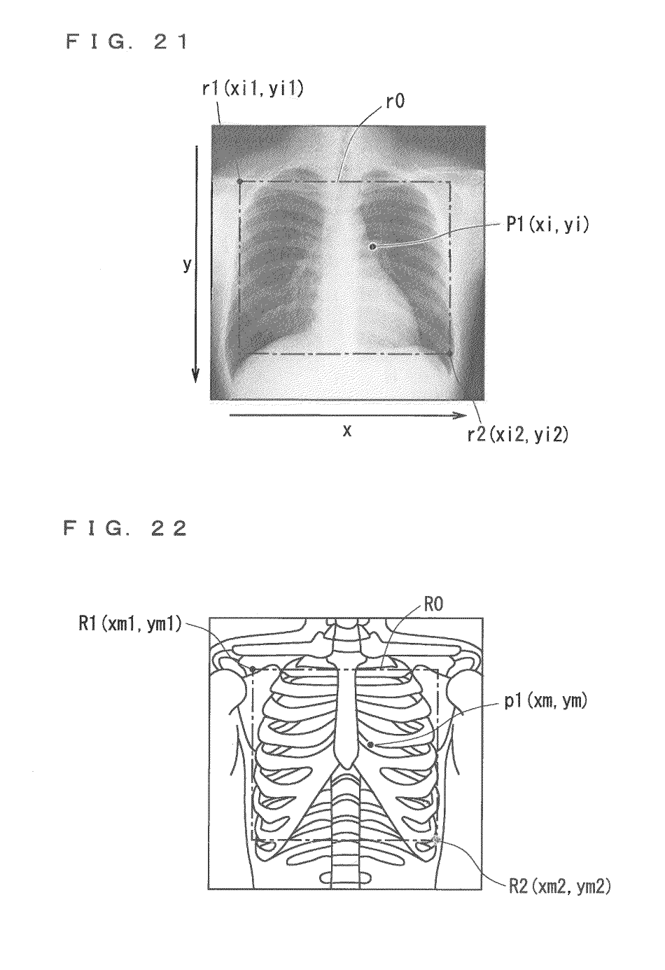

FIGS. 21 and 22 are diagrams for describing the first processing performed in step S7.

FIG. 21 shows the medical image displayed by the display unit 34, the diagnostic area r0 that is set with respect to the medical image in step S4 as described above, and coordinates (xi, yi) of a point P1 designated as the attention location in step S6. FIG. 22 shows the anatomical model included in the location correspondence information 122a, the reference area R0 that is set in advance with respect to the anatomical model, and coordinates (xm, ym) of a point p1 that corresponds to the attention location.

In the first processing, the body part identification unit 306 associates the diagnostic area r0 on the medical image with the reference area R0 in the anatomical model in accordance with the following equations (1) and (2).

(xi−xi1)/(xi2−xi1)=(xm−xm1)/(xm2−xm1) (1)

(yi−yi1)/(yi2−yi1)=(ym−ym1)/(ym2−ym1) (2)

In the first processing, the body part identification unit 306 converts the coordinates (xi, yi) of the point P1 as the attention location on the medical image into the coordinates (xm, ym) of the point p1 as the attention location in the anatomical model in accordance with the following equations (3) and (4).

xm=(xi−xi1)/(xi2−xi1)×(xm2−xm1)+xm1 (3)

ym=(yi−yi1)/(yi2−yi1)×(ym2−ym1)+ym1 (4)

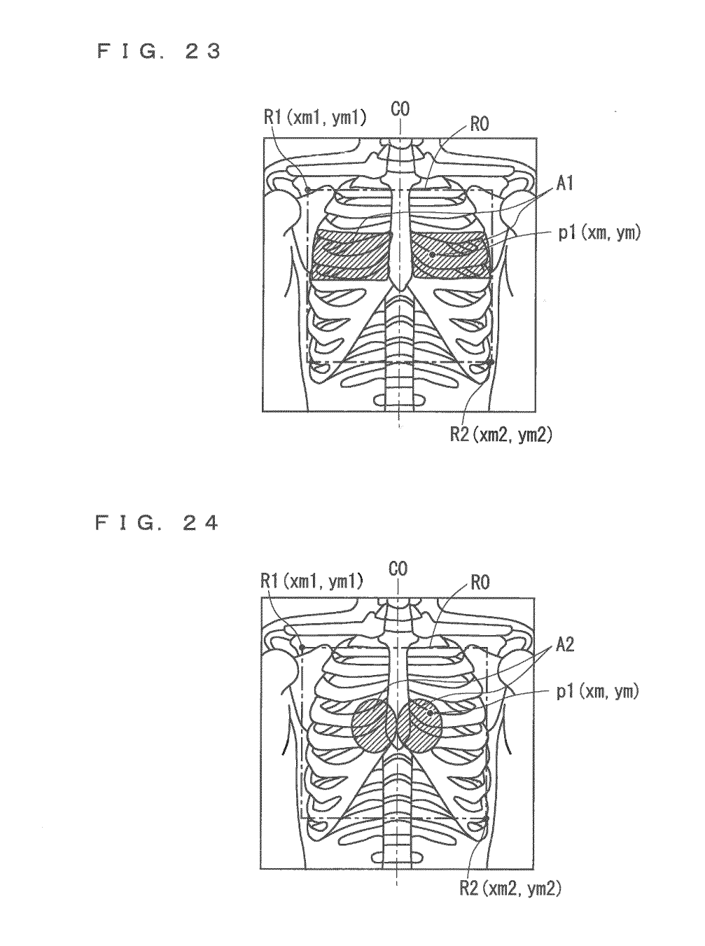

FIGS. 23-25 are diagrams for describing the second processing performed in step S7.

In the second processing, the body part identification unit 306 compares the location information (the coordinates (xm, ym) of the point p1) on the attention location in the anatomical model obtained in the first processing with a predetermined area (e.g., the areas A1-A3) in the anatomical model for each term concerning a basic body part as an anatomical section. As a result, two or more terms concerning a basic body part can be identified.

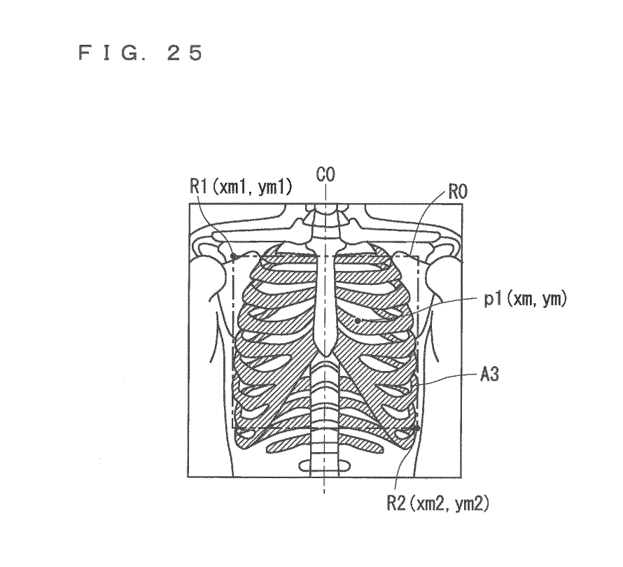

FIG. 23 shows a relationship between a location of the area A1 concerning a middle lung field as an anatomical section in the anatomical model and a location indicated by the location information (the coordinates (xm, ym) of the point p1) on the attention location. FIG. 24 shows a relationship between a location of the area A2 concerning a hilum of a lung as an anatomical section in the anatomical model and a location indicated by the location information (the coordinates (xm, ym) of the point p1) on the attention location. FIG. 25 shows a relationship between a location of the area A3 concerning a rib as an anatomical section in the anatomical model and a location indicated by the location information (the coordinates (xm, ym) of the point p1) on the attention location.

In the examples of FIGS. 23-25, the area A1 concerning a middle lung field, the area A2 concerning a hilum of a lung, the area A3 concerning a rib, and the point p1 overlap one another.

As described above, whether the point p1 overlaps a predetermined area in the anatomical model is judged in the second processing for each term concerning a basic body part as an anatomical section. In this case, a flag “1: display” is set when the point p1 overlaps the predetermined area, and a flag “0: not display” is set when the point p1 does not overlap the predetermined area. A term concerning a basic body part with respect to which the flag “1: display” is set is identified as a candidate for the term concerning the basic body part. In the examples of FIGS. 23-25, flags “1: display” are set with respect to a middle lung field, a hilum of a lung, and a rib. Therefore, terms “middle lung field”, “hilum of a lung”, and “rib” are identified as candidates for the term concerning the basic body part.

The body part identification unit 306 judges, for each candidate for the term concerning the basic body part with respect to which the flag “1: display” is set, whether the point p1 is located in a left area or in a right area of the anatomical model by using a center CO of the anatomical model in a horizontal direction as a reference. In accordance with a result of the judgment, a term “left” or “right” is added to each candidate for the term concerning the basic body part with respect to which the flag “1: display” is set. In the examples of FIGS. 23-25, the point p1 is located to the left of the center CO. Therefore, the term “left” is added to each candidate for the term concerning the basic body part with respect to which the flag “1: display” is set. For example, the term “left” is added to each of terms “middle lung field”, “hilum of a lung”, and “rib”, so that terms “left middle lung field”, “hilum of a left lung”, and “left rib” are generated.

As described above, the processing to add the term “left” or “right” to each identified candidate for the term is performed after setting the flag “1: display” or “0: not display” in the present embodiment. The present invention, however, is not limited to this structure. For example, a term concerning a basic body part as an anatomical section to which the term “left” or “right” is added in advance may be prepared.

In step S8, the body part designation unit 308 designates one of two or more terms as candidates for the term that belongs to the item “basic body part” as identified in step S7. From among the two or more terms that belong to the item “basic body part” identified in step S7, a term that has higher priority is designated as the term that belongs to the item “basic body part” in an initial state. Specifically, the body part designation unit 308 designates a term that is associated with the highest priority degree of all the two or more terms that belong to the item “basic body part” identified in step S7 with reference to the priority information 122b, for example. For example, when the two or more terms as candidates for the term that belongs to the item “basic body part” are a middle lung field, a hilum of a lung, and a rib, the middle lung field, which is associated with the highest priority degree in the priority information 122b shown in FIG. 6, is designated.

In step S9, the information extraction unit 309 extracts information on the term that belongs to the item “basic body part” designated in step S8 from the combination frequency information 122d, which is a combination information group, stored in the support information 122. In this case, when the term “middle lung field” is designated in step S8, for example, information on one or more combinations of terms concerning the middle lung field and information indicating frequency of the one or more combinations of terms are extracted from the combination frequency information 122d.

In step S10, the display controller 304 causes the display unit to display a support template based on the information on one or more combinations of terms and the information indicating frequency of the one or more combinations of terms as extracted in step S9. In the support template, a term list including a list of terms as a plurality of options is displayed based on the information on one or more combinations of terms extracted from the combination frequency information 122d in step S9.

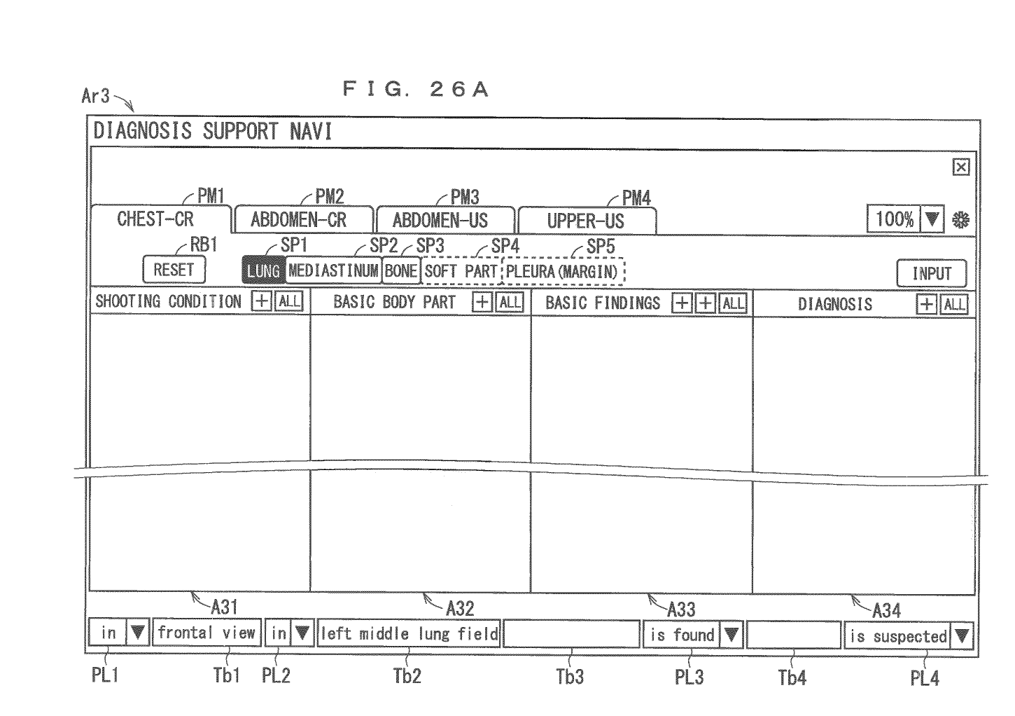

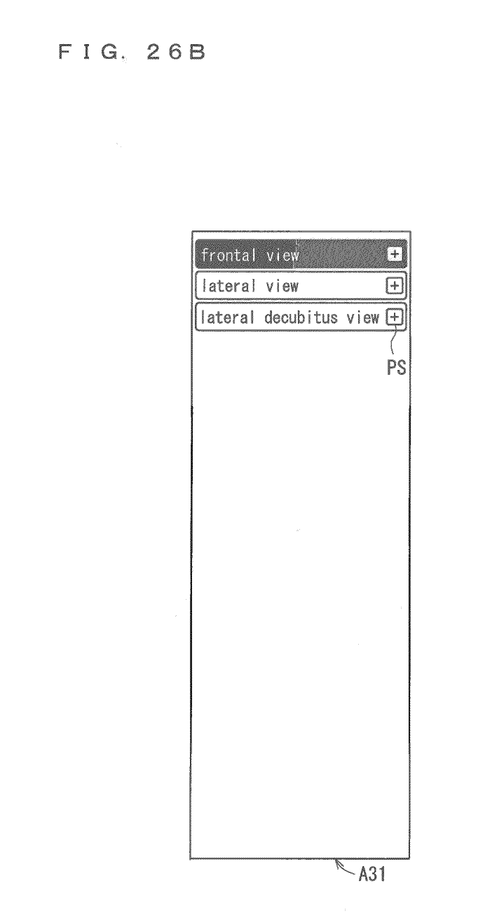

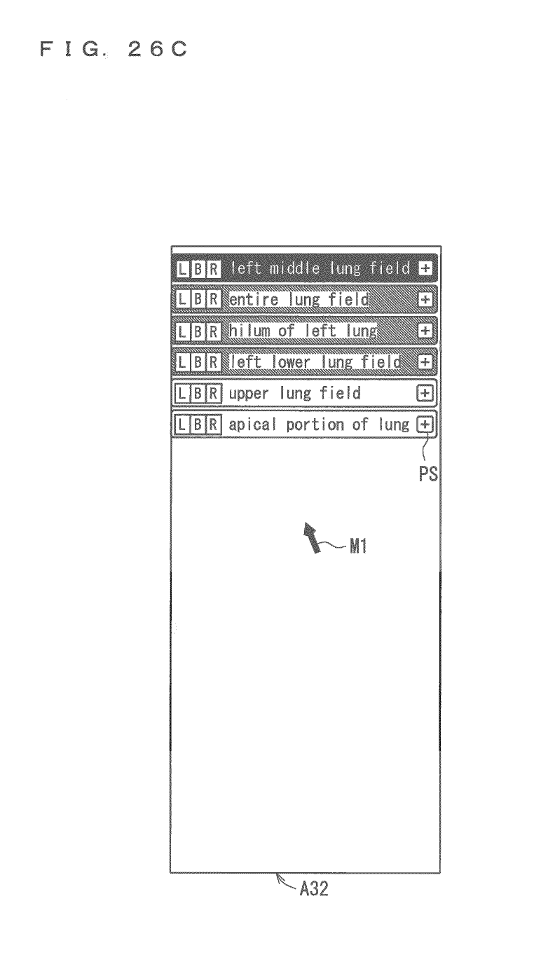

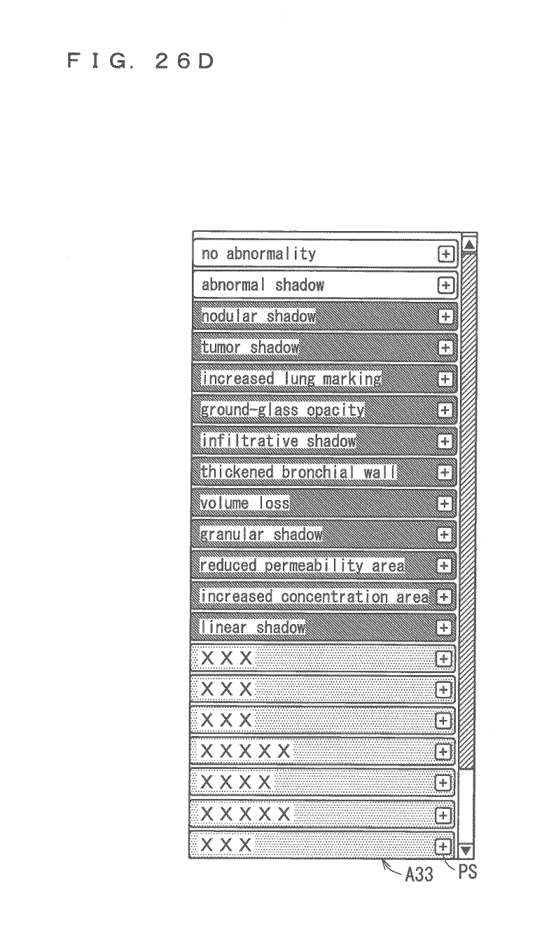

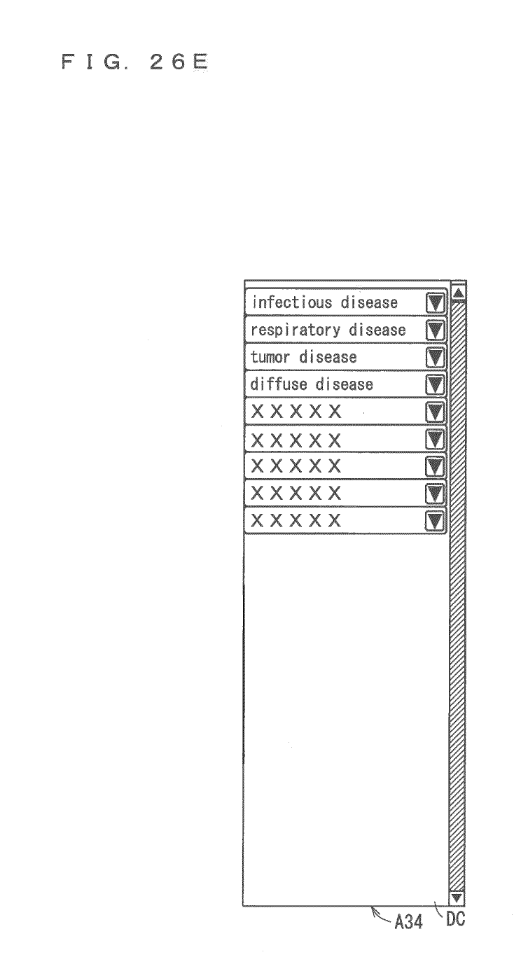

FIGS. 26A to 26E show an example of the support template. As shown in FIGS. 26A to 26E, in the present embodiment, the term concerning the basic body part designated in step S8 is automatically designated in the selection area A32. In the example of FIGS. 26A to 26E, a term “left middle lung field” is designated as the term that belongs to the item “basic body part”.

In step S10, the display controller 304 causes the display unit to display, in the term list, one or more terms that belong to the item “basic findings” and are included in the information on one or more combinations of terms extracted in step S9 so that the one or more terms are distinguishable from one or more remaining terms that belong to the item “basic findings”. For example, the association identification unit 310 identifies one or more combinations of terms that are indicated by the combination frequency information 122d and correspond to the one term designated in step S8. The display controller 304 then causes the display unit to display, in the term list, one or more terms that belong to the item “basic findings” and are included in the information on one or more combinations of terms based on the one or more combinations of terms identified by the association identification unit 310 so that the one or more terms are distinguishable from one or more remaining terms that belong to the item “basic findings”, for example.

In the example of FIGS. 26A to 26E, terms that belong to the item “basic findings” and are associated with the term “left middle lung field” that belongs to the item “basic body part” are shown by hatched display elements in the selection area A33. One or more terms that belong to the item “basic findings” and are associated with the designated term that belongs to the item “basic body part” can thus easily be known. As a result, designation of terms in creating a diagnostic result report is further facilitated.

In step S10, the display controller 304 causes the display unit to display, in the term list, one or more terms that belong to the item “basic findings” and are included in the information on one or more combinations of terms extracted in step S9 in accordance with the information indicating frequency of the one or more combinations of terms. For example, the association identification unit 310 identifies one or more combinations of terms that are indicated by the combination frequency information 122d and correspond to the one term designated in step S8. The display controller 304 then causes the display unit to display, in the term list, one or more terms that belong to the item “basic findings”, as the second item, and are included in the one or more combinations of terms identified by the association identification unit 310 in accordance with frequency of appearance in the one or more combinations of terms, for example.

In the example of FIGS. 26A to 26E, density of hatched display elements showing terms that belong to the item “basic findings” displayed in the term list increases with increasing frequency of appearance of each of the terms in the information on the one or more combinations of terms extracted in step S9. One or more terms that belong to the item “basic findings” and are strongly associated with the designated term that belongs to the item “basic body part” can thus easily be known. As a result, designation of terms in creating a diagnostic result report is further facilitated.

In the selection areas A31-A34, a detail designate button PS is provided on the right side of each option for the term. When the detail designate button PS is pressed with the mouse pointer M1, a detail window OW1 in which a detailed element (e.g., a modifier) that modifies the designated term can be input is displayed so as to be overlaid on the support template.

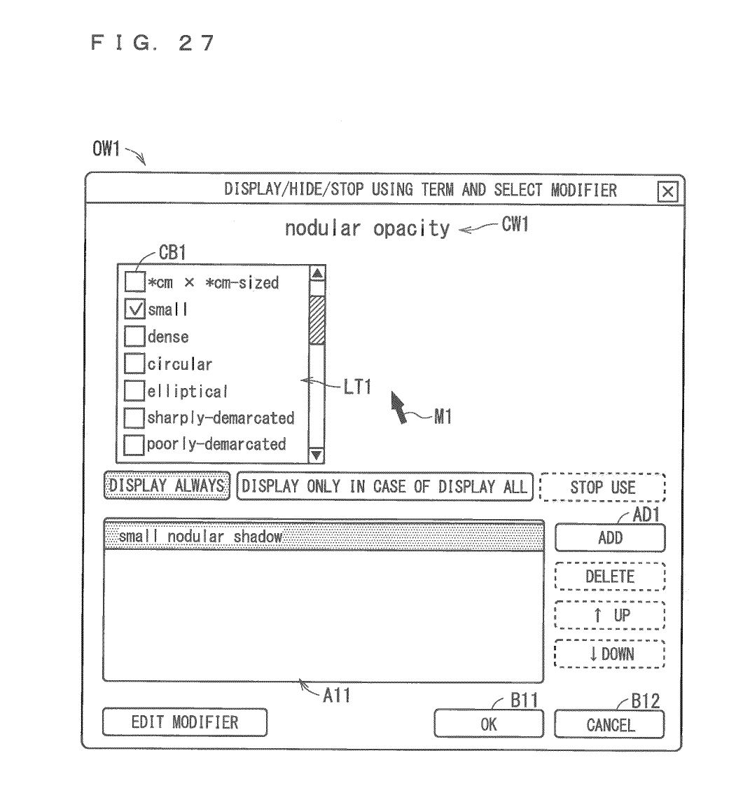

FIG. 27 shows an example of the detail window OW1 for the item “basic findings”. In the detail window OW1, a term (also referred to as an addition target term) CW1 (e.g., nodular shadow) to which a detailed element is to be added is shown in an upper part, and candidates for the detailed element to be added (e.g., *cm×*cm-sized, small, dense, . . . ) are listed under the addition target term. When any of check boxes CB1 provided on the left sides of the respective candidates for the detailed element is checked with the mouse pointer M1, and an add button AD1 is pressed, a term obtained by adding the checked detailed element to the addition target term CW1 is displayed in an area A11. An OK button B11 and a cancel button B12 are provided in a lower part of the detail window OW1. When the cancel button B12 is pressed with the mouse pointer M1, display of the detail window OW1 is simply terminated. When the OK button B11 is pressed with the mouse pointer M1, the term displayed in the area A11 is employed, and display of the detail window OW1 is terminated. For example, when a term “small nodular shadow” that is obtained by adding a modifier “small” to a term “nodular shadow” is displayed in the area A11, the term “small nodular shadow” is displayed in the text box Tb3 as the term that belongs to the item “basic findings” in response to pressing of the OK button B11.

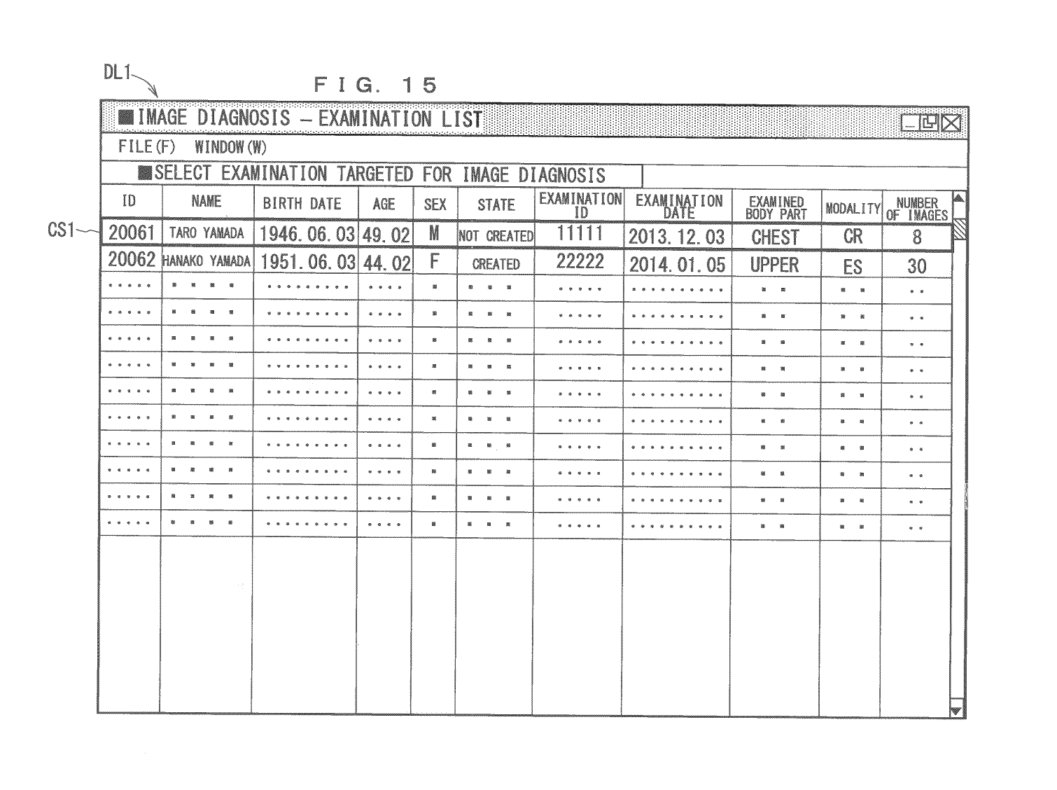

In step S11 shown in FIG. 13, the controllers 11 and 31 receive input in accordance with a doctor's operation on the operation unit 33 in the support template and the like. For example, input regarding change of a category achieved by pressing of any of the category buttons SP1-SP5, designation of a term that belongs to the item “basic findings” achieved by the element designation unit 311, and the like is received in accordance with the operation on the operation unit 33.

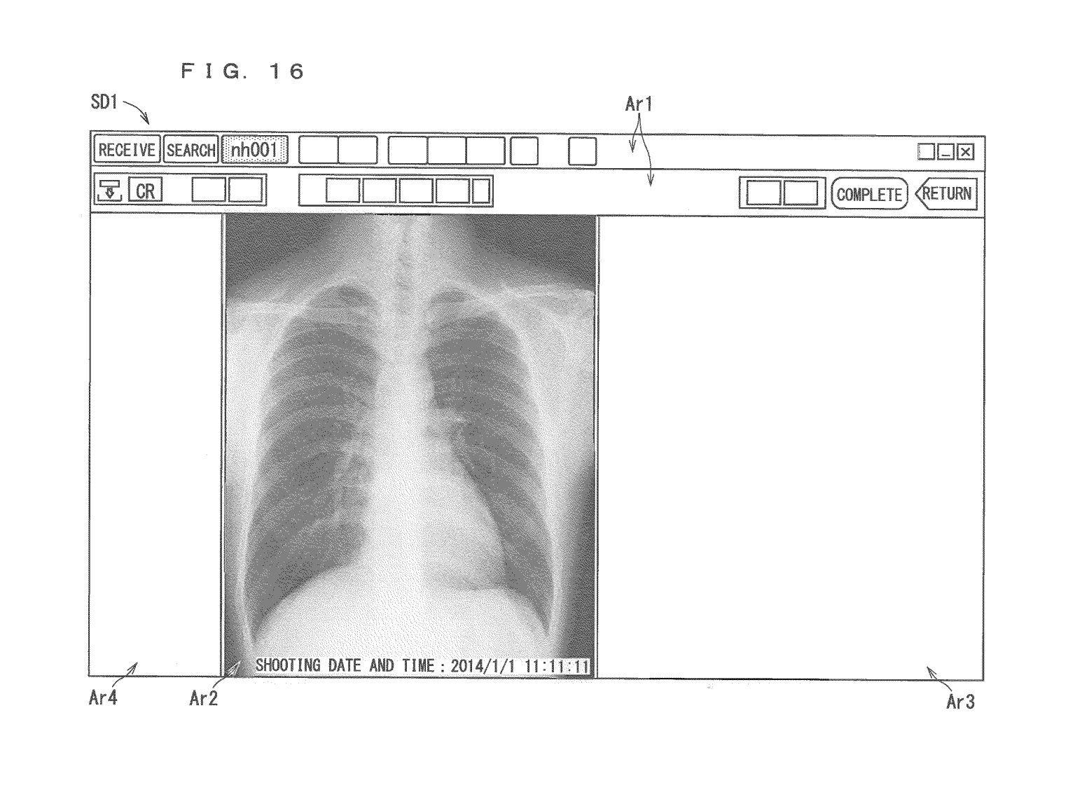

In step S12, the body part designation unit 308 judges whether an instruction to change a category has been issued in the support template. When the instruction to change a category has not been issued, processing proceeds to step S13. When the instruction to change a category has been issued, processing proceeds to step S23 shown in FIG. 14.

In step S13, the element designation unit 311 judges whether a term that belongs to the item “basic findings” has been designated in the selection area A33 of the support template. When the term that belongs to the item “basic findings” has not been designated, processing returns to step S11. When the term that belongs to the item “basic findings” has been designated, processing proceeds to step S14.

In step S14, the display controller 304 causes the display unit to change, in the term list, a method for displaying the term that belongs to the item “diagnosis” in accordance with the term that belongs to the item “basic findings” designated in step S11. For example, the association identification unit 310 identifies at least one combination of terms that is indicated by the combination frequency information 122d and corresponds to a combination of the one term designated by the body part designation unit 308 and each of the one or more terms designated by the element designation unit 311. The display controller 304 then causes the display unit to display, in the term list, one or more terms that belong to the item “diagnosis” and are included in the at least one combination of terms identified by the association identification unit 310 based on the at least one combination of terms so that the one or more terms are distinguishable from the other terms, for example. Specifically, the display controller 304 causes the display unit to display, in the term list, the one or more terms that belong to the item “diagnosis” and are included in the at least one combination of terms identified by the association identification unit 310 so that the one or more terms are distinguishable from one or more remaining terms that belong to the item “diagnosis”, for example.

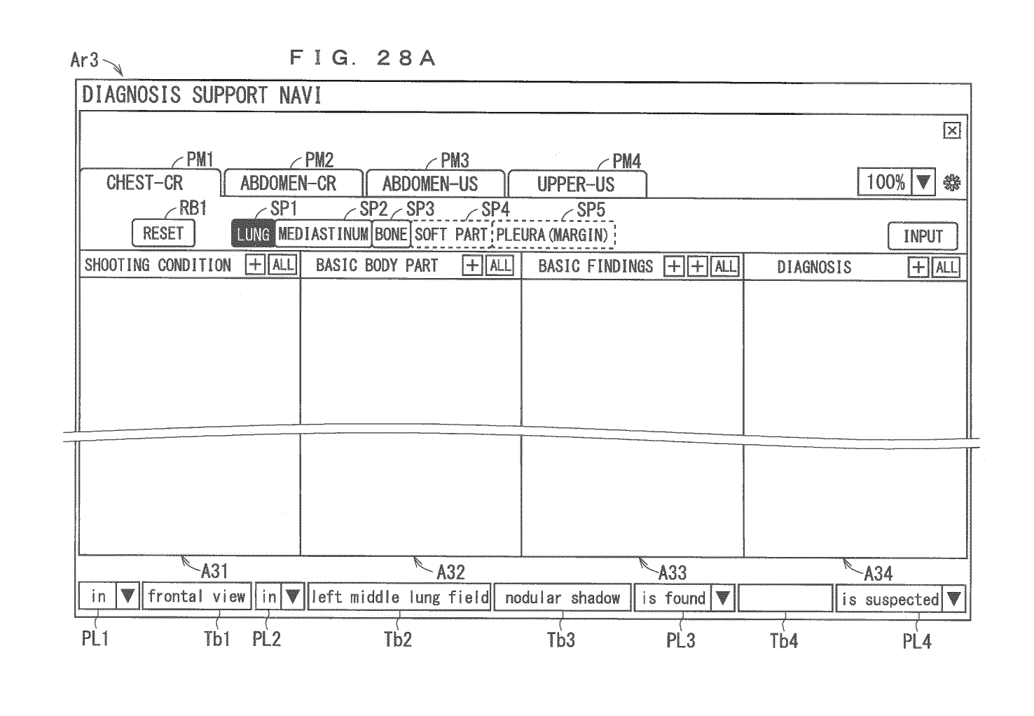

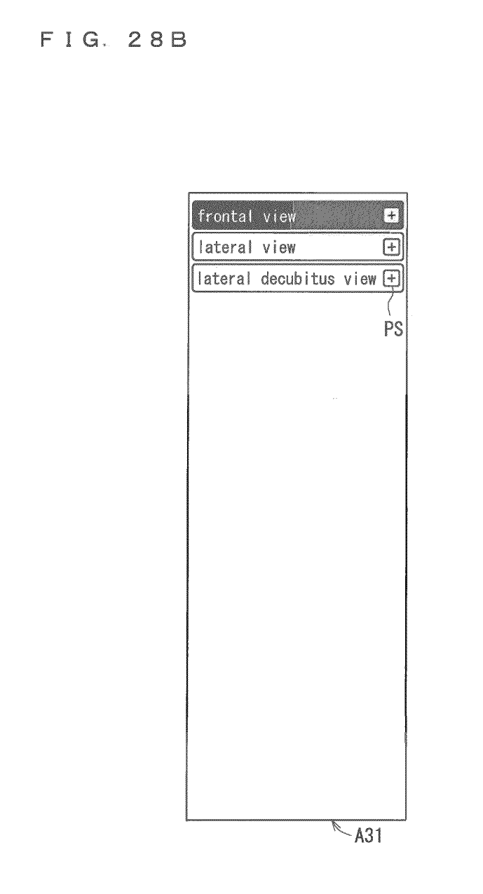

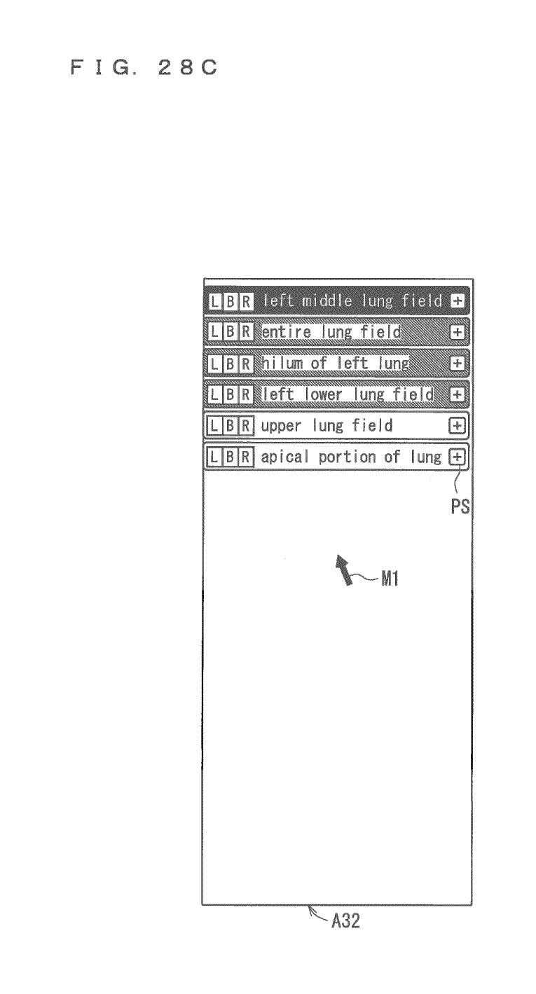

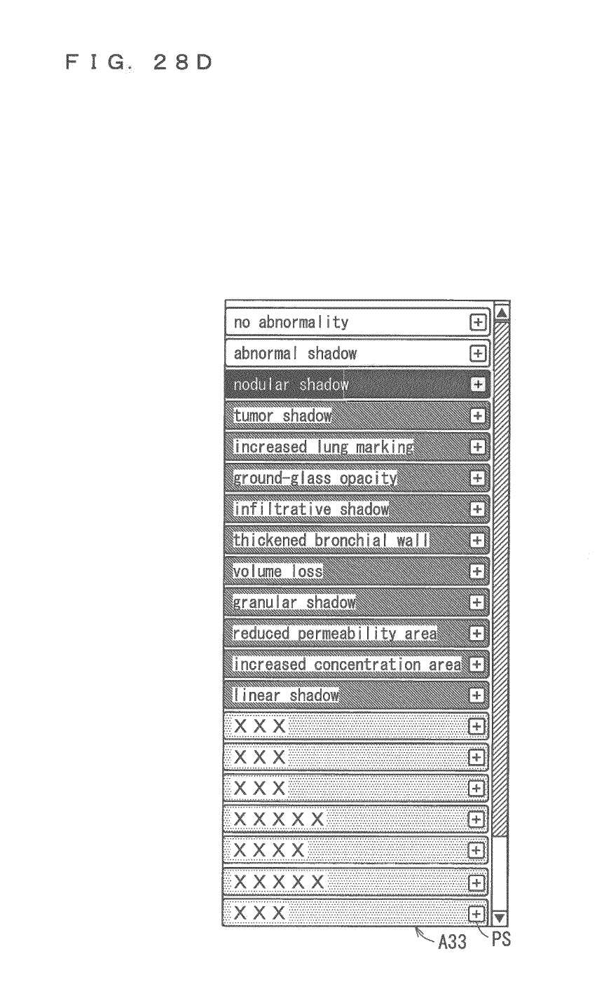

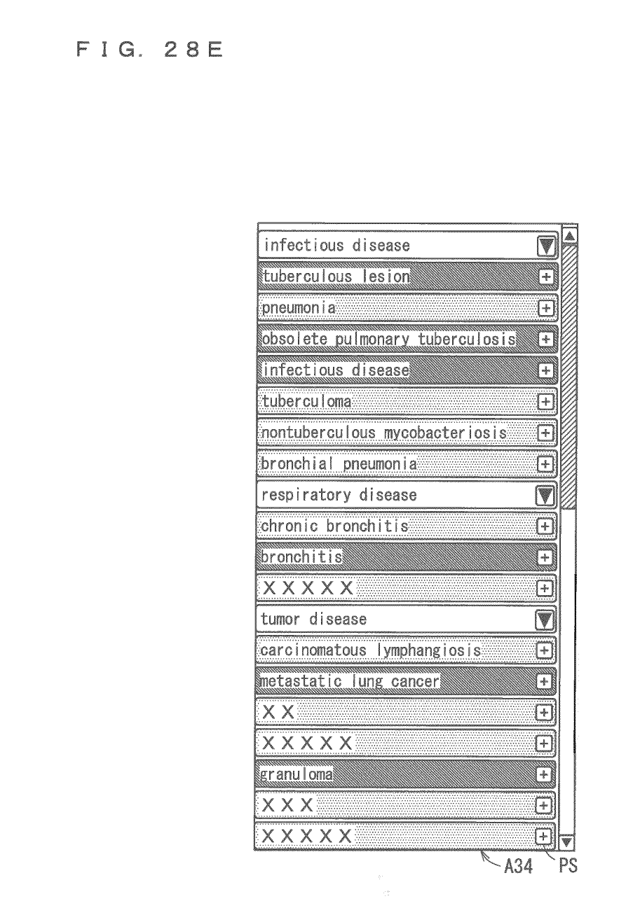

FIGS. 28A to 28E show an example of the support template. In the example of FIGS. 28A to 28E, terms that belong to the item “diagnosis” and are associated with a combination of the term “left middle lung field” that belongs to the item “basic body part” and the term “nodular shadow” that belongs to the item “basic findings” are shown by hatched display elements in the selection area A34. One or more terms that belong to the item “diagnosis” and are associated with a combination of the designated term that belongs to the item “basic body part” and the designated term that belongs to the item “basic findings” can thus easily be known. As a result, designation of terms in creating a diagnostic result report is further facilitated.

In this step, the display controller 304 causes the display unit to display, in the term list, the one or more terms that belong to the item “diagnosis” and are included in the at least one combination of terms identified by the association identification unit 310 in accordance with frequency of appearance in the at least one combination of terms, for example. That is to say, terms that belong to the item “diagnosis” are displayed in accordance with frequency of appearance in at least one combination of terms that is indicated by the combination frequency information 122d and corresponds to a combination of the designated term that belongs to the item “basic body part” and each of the designated one or more terms that belong to the item “basic findings”.

In the example of FIGS. 28A to 28E, density of hatched display elements showing terms that belong to the item “diagnosis” displayed in the term list increases with increasing frequency of appearance of each of the terms in the at least one combination of terms identified by the association identification unit 310 as in the example of FIGS. 26A to 26E. One or more terms that belong to the item “diagnosis” and are strongly associated with a combination of the designated term that belongs to the item “basic body part” and the designated term that belongs to the item “basic findings” can thus easily be known. As a result, designation of terms in creating a diagnostic result report is further facilitated.

In step S15, the controllers 11 and 31 receive input in accordance with a doctor's operation on the operation unit 33 in the support template and the like. For example, input regarding cancellation of designation of a term achieved by pressing of the reset button RB1, change of a category achieved by pressing of any of the category buttons SP1-SP5, designation of a term that belongs to the item “diagnosis” achieved by the element designation unit 311, and the like is received in accordance with the operation on the operation unit 33.

In step S16, the controllers 11 and 31 judge whether an instruction to cancel designation of the term has been issued by pressing of the reset button RB1 with the mouse pointer M1. When the instruction to cancel designation of the term has not been issued, processing proceeds to step S17. When the instruction to cancel designation of the term has been issued, designation of the term that belongs to the item “basic findings” is canceled, and processing returns to step S11.

In step S17, judgment that is similar to that made in step S12 described above is made. When the instruction to change a category has not been issued, processing proceeds to step S18. When the instruction to change a category has been issued, processing proceeds to step S23 shown in FIG. 14.

In step S18, the element designation unit 311 judges whether a term that belongs to the item “diagnosis” has been designated in the selection area A34 of the support template. When the term that belongs to the item “diagnosis” has not been designated, processing returns to step S15. When the term that belongs to the item “diagnosis” has been designated, processing proceeds to step S19. When processing proceeds to step S19, terms are displayed in all the text boxes Tb1 to Tb4. In this case, a finding sentence is generated based on terms displayed in the text boxes Tb1-Tb4 and predicates designated in the predicate lists PL1-PL4, for example, and is automatically input into a comment display area Ar21 (FIG. 18) in the fourth area Ar4 of the diagnosis support screen SD1. The finding sentence may be generated, and displayed in the comment display area Ar21 in the fourth area Ar4 of the diagnosis support screen SD1 in response to pressing of an input button provided in the support template, for example.

In step S19, the controllers 11 and 31 receive input in accordance with a doctor's operation on the operation unit 33 in the support template and the like. For example, input regarding cancellation of designation of a term achieved by pressing of the reset button RB1, registration of a diagnostic result report achieved by pressing of a set button FB1, and the like is received in accordance with the operation on the operation unit 33.

In step S20, judgment that is similar to that made in step S16 described above is made. When the instruction to cancel designation of the term has not been issued, processing proceeds to step S21. When the instruction to cancel designation of the term has been issued, designation of the term that belongs to the item “basic findings” and the term that belongs to the item “diagnosis” is canceled, and processing returns to step S11. When the instruction to cancel designation of the term has been issued, designation of only the term that belongs to the item “diagnosis” may be canceled, and processing may return to step S15, for example.

In step S21, the registration designation unit 312 judges whether an instruction to register a diagnostic result report has been issued by pressing of the set button FB1 with the mouse pointer M1. When the instruction to register a diagnostic result report has not been issued, processing returns to step S19. When the instruction to register a diagnostic result report has been issued, processing proceeds to step S22.

In step S22, the storage controller 307 causes the medical care information 121 to store therein a diagnostic result report that includes a finding sentence generated based on the one term designated for the item “basic body part” and terms that are designated for the items “basic findings” and “diagnosis”. Specifically, the finding sentence displayed in the comment display area Ar21 in the fourth area Ar4 of the diagnosis support screen SD1 is stored in the medical care information 121.

In step S23 shown in FIG. 14, in response to change of a category achieved by pressing of any of the category buttons SP1-SP5, the body part designation unit 308 designates terms concerning the item “basic body part” that correspond to the category after change. For example, when the category button SP2 is pressed in a state in which a category “lung” or “bone” is designated, terms that belong to a category for a diagnostic result report as an input target are changed from terms that belong to the category “lung” or “bone” to terms that belong to a category “mediastinum”. In this case, the body part designation unit 308 designates, from among the two or more terms as candidates for the term that belongs to the item “basic body part” identified in step S7, one term that corresponds to the category after change.

The following describes, as a specific example, a case where the candidates for the term that belongs to the item “basic body part” identified in step S7 are a term “middle lung field” that corresponds to the category “lung”, a term “hilum of a lung” that corresponds to the category “mediastinum”, and a term “rib” that corresponds to the category “bone”. When the terms that belong to the category for the diagnostic result report as an input target are changed from the terms that belong to the category “lung” or “bone” to the terms that belong to the category “mediastinum”, the body part designation unit 308 designates the term “hilum of a lung” that corresponds to the category “mediastinum”. When the terms that belong to the category for the diagnostic result report as an input target are changed from the terms that belong to the category “lung” or “mediastinum” to the terms that belong to the category “bone”, the body part designation unit 308 designates the term “rib” that corresponds to the category “bone”. When the terms that belong to the category for the diagnostic result report as an input target are changed from the terms that belong to the category “mediastinum” or “bone” to the terms that belong to the category “lung”, the body part designation unit 308 designates the term “middle lung field” that corresponds to the category “lung”.

In step S24, the information extraction unit 309 extracts information on terms that belong to the item “basic body part” designated in step S23 from the combination frequency information 122d, which is the combination information group, stored in the support information 122. In this case, when the category “mediastinum” is designated in step S23, for example, information on one or more combinations of terms that belong to the category “mediastinum” and information indicating frequency of the one or more combinations of terms are extracted from the combination frequency information 122d. When the category “bone” is designated in step S23, for example, information on one or more combinations of terms that belong to the category “bone” and information indicating frequency of the one or more combinations of terms are extracted from the combination frequency information 122d. When the category “lung” is designated in step S23, for example, information on one or more combinations of terms that belong to the category “lung” and information indicating frequency of the one or more combinations of terms are extracted from the combination frequency information 122d.

In step S25, the display controller 304 causes the display unit to display the support template based on the information on the one or more combinations of terms and the information indicating the frequency of the one or more combinations of terms, both extracted in step S24. In the support template, a term list including a list of terms as a plurality of options is displayed based on the information on the one or more combinations of terms extracted from the combination frequency information 122d in step S24.

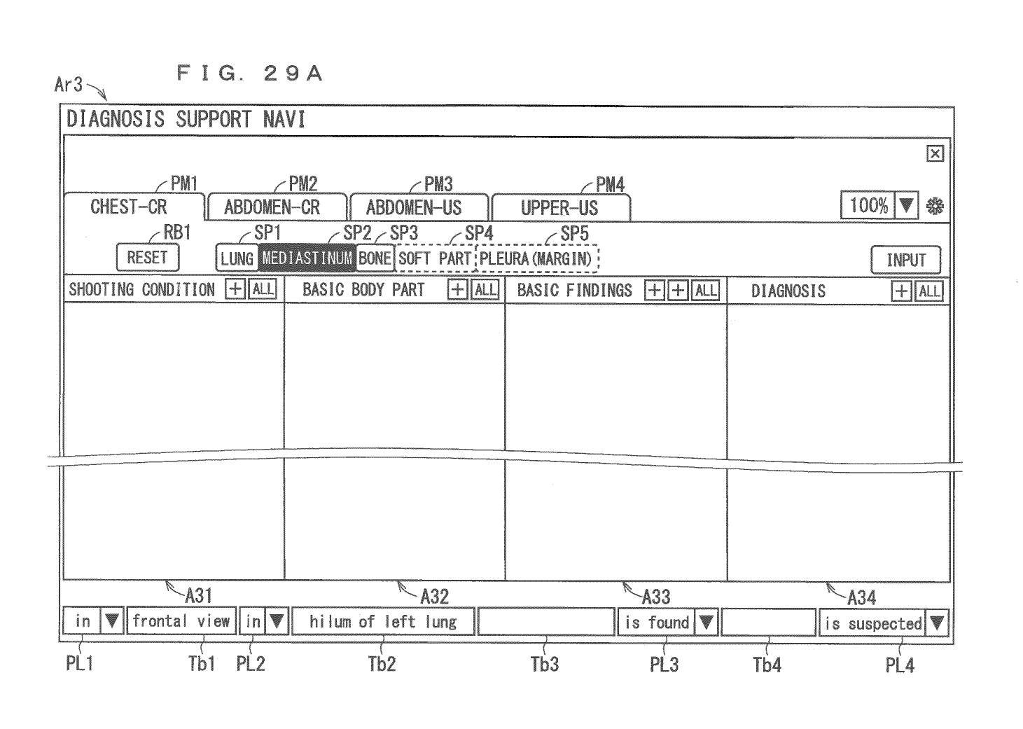

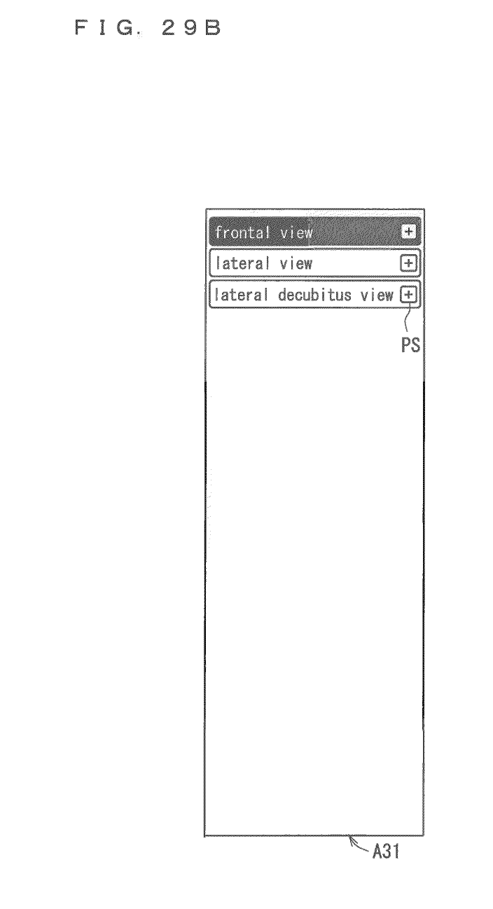

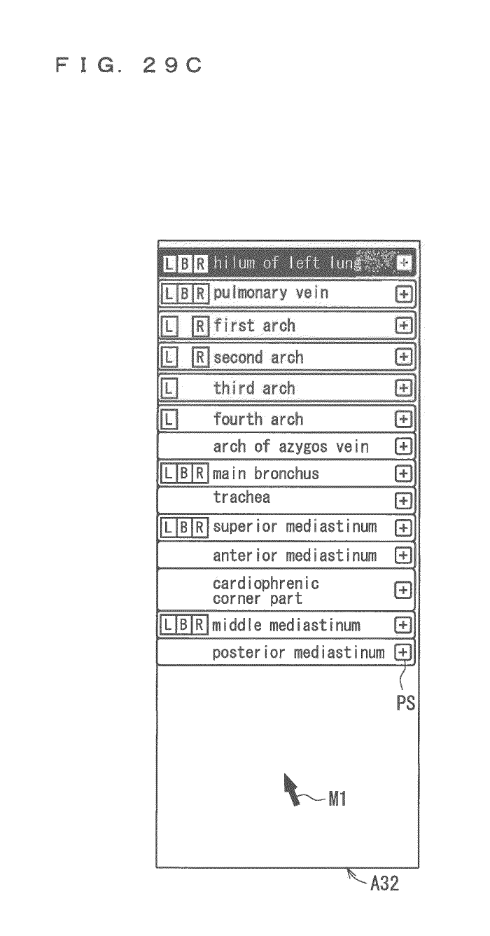

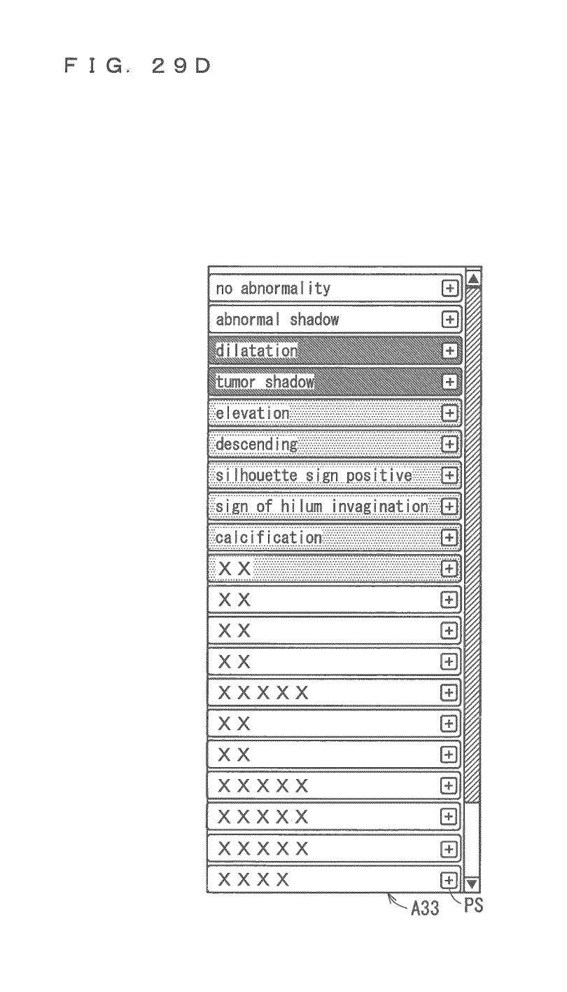

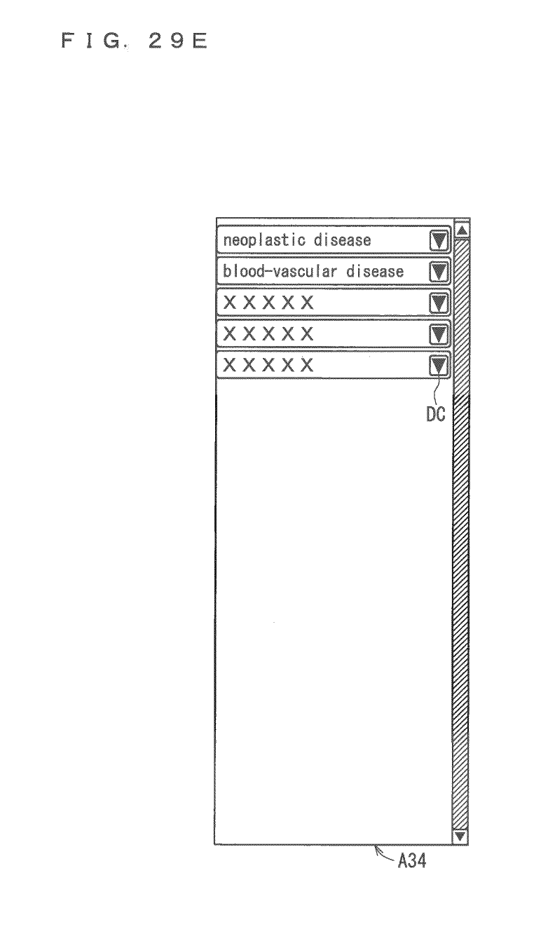

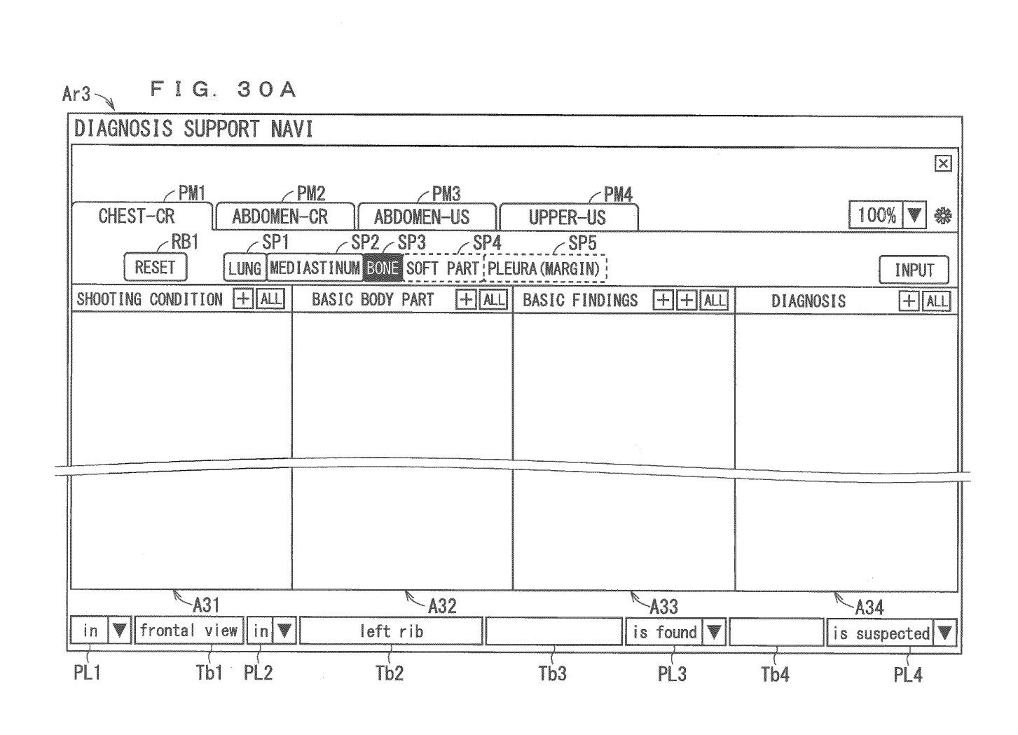

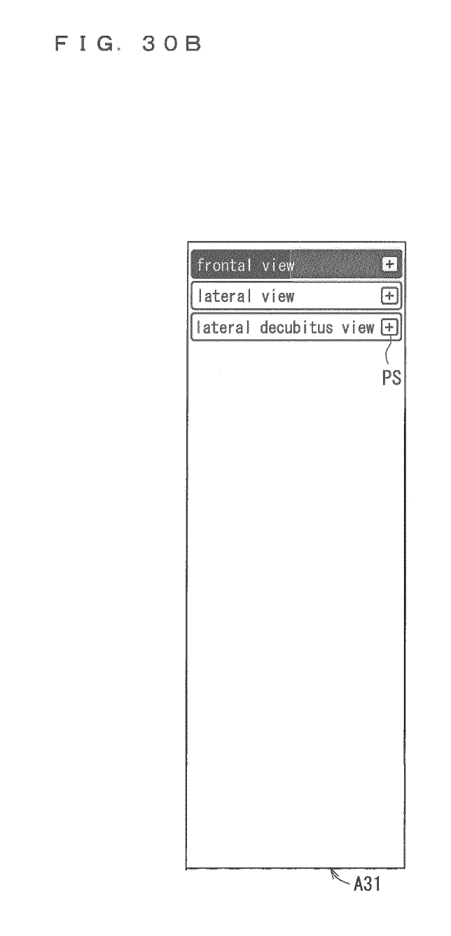

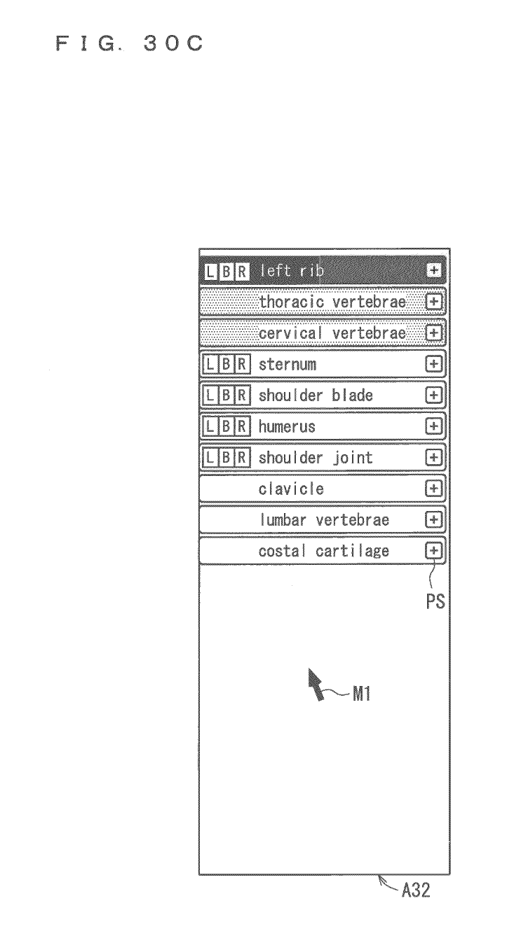

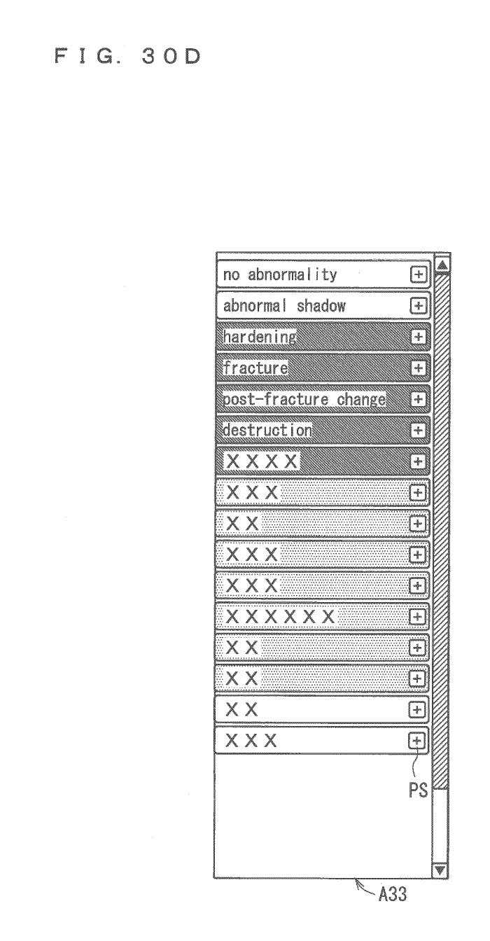

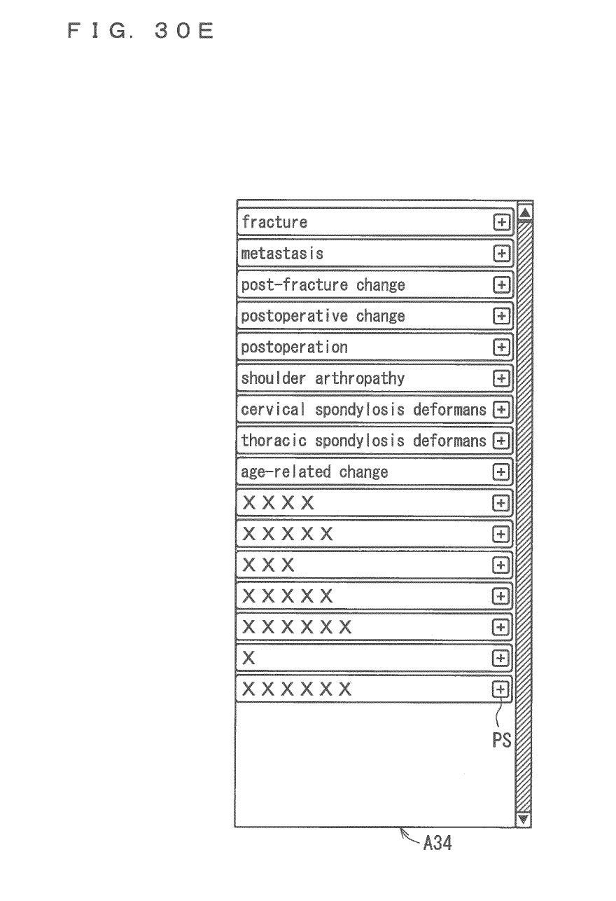

FIGS. 29A to 29E show an example of the support template displayed when a category is changed to the category “mediastinum” in step S23, and a term “hilum of a lung” is identified as the term that belongs to the item “basic body part”. As shown in FIGS. 29A to 29E, a term “hilum of a left lung” that is obtained by adding a modifier “left” to the term “hilum of a lung” that belongs to the item “basic body part” designated in step S23 is designated automatically in the selection area A32 as the term that belongs to the item “basic body part”. FIGS. 30A to 30E show an example of the support template displayed when the category is changed to the category “bone” in step S23, and the term “rib” is identified as the term that belongs to the item “basic body part”. As shown in FIGS. 30A to 30E, a term “left rib” that is obtained by adding a modifier “left” to the term “rib” that belongs to the item “basic body part” designated in step S23 is designated automatically in the selection area A32 as the term that belongs to the item “basic body part”.

In step S25, the display controller 304 causes the display unit to display, in the term list, one or more terms that belong to the item “basic findings” and are included in the information on the one or more combinations of terms extracted in step S24 so that the one or more terms are distinguishable from one or more remaining terms that belong to the item “basic findings”. For example, the association identification unit 310 identifies one or more combinations of terms that are indicated by the combination frequency information 122d and correspond to the one term designated in step S23. The display controller 304 then causes the display unit to display, in the term list, one or more terms that belong to the item “basic findings” and are included in the information on the one or more combinations of terms identified by the association identification unit 310 based on the one or more combinations of terms so that the one or more terms are distinguishable from one or more remaining terms that belong to the item “basic findings”, for example.

In the example of FIGS. 29A to 29E, terms that belong to the item “basic findings” and are associated with the term “hilum of a left lung” that belongs to the item “basic body part” are shown by hatched display elements in the selection area A33. In the example of FIGS. 30A to 30E, terms that belong to the item “basic findings” and are associated with the term “left rib” that belongs to the item “basic body part” are shown by hatched display elements in the selection area A33. One or more terms that belong to the item “basic findings” and are associated with the designated term that belongs to the item “basic body part” can thus easily be known. As a result, designation of terms in creating a diagnostic result report is further facilitated.

In step S25, the display controller 304 causes the display unit to display, in the term list, one or more terms that belong to the item “basic findings” and are included in the information on the one or more combinations of terms extracted in step S24 in accordance with the information indicating the frequency of the one or more combinations of terms. For example, the association identification unit 310 identifies one or more combinations of terms that are indicated by the combination frequency information 122d and correspond to the one term designated in step S23. The display controller 304 then causes the display unit to display, in the term list, one or more terms that belong to the item “basic findings”, which is the second item, and are included in the one or more combinations of terms identified by the association identification unit 310 in accordance with frequency of appearance in the one or more combinations of terms, for example.

In the examples of FIGS. 29A to 29E and 30A to 30E, density of hatched display elements showing terms that belong to the item “basic findings” displayed in the term list increases with increasing frequency of appearance of each of the terms in the information on the one or more combinations of terms extracted in step S24, as in the example of FIGS. 26A to 26E. One or more terms that belong to the item “basic findings” and are strongly associated with the designated term that belongs to the item “basic body part” can thus easily be known. As a result, designation of terms in creating a diagnostic result report is further facilitated.

After processing in step S25 is performed, processing proceeds to step S11 shown in FIG. 13, and processing that is similar to that in steps S11-S25 described above is performed.

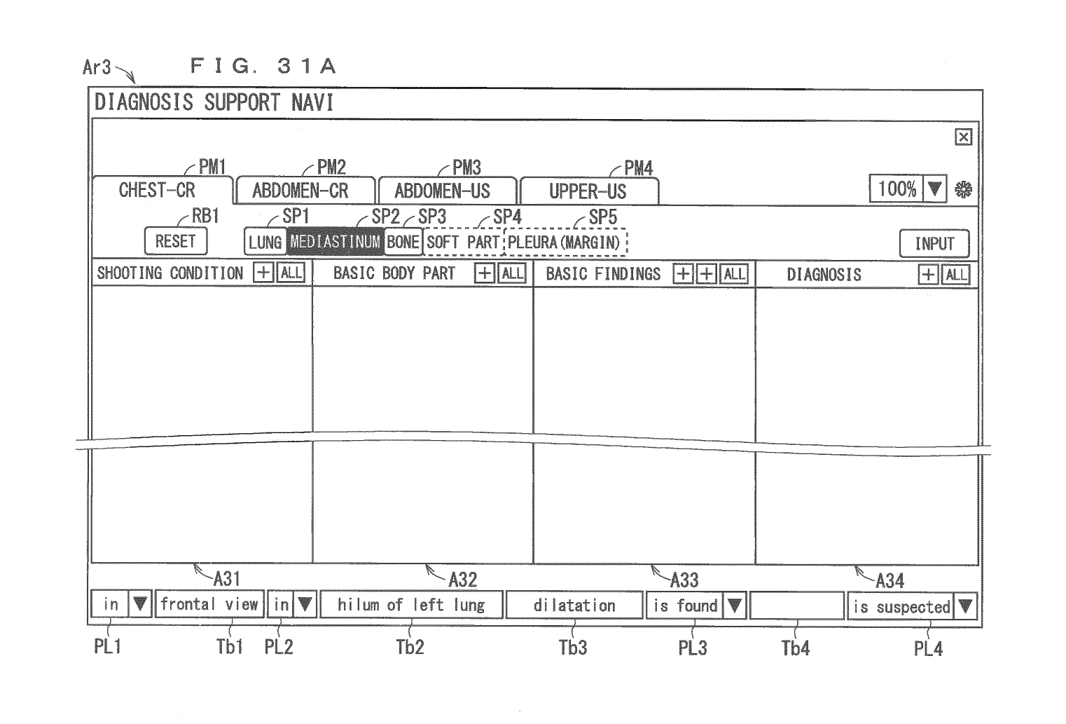

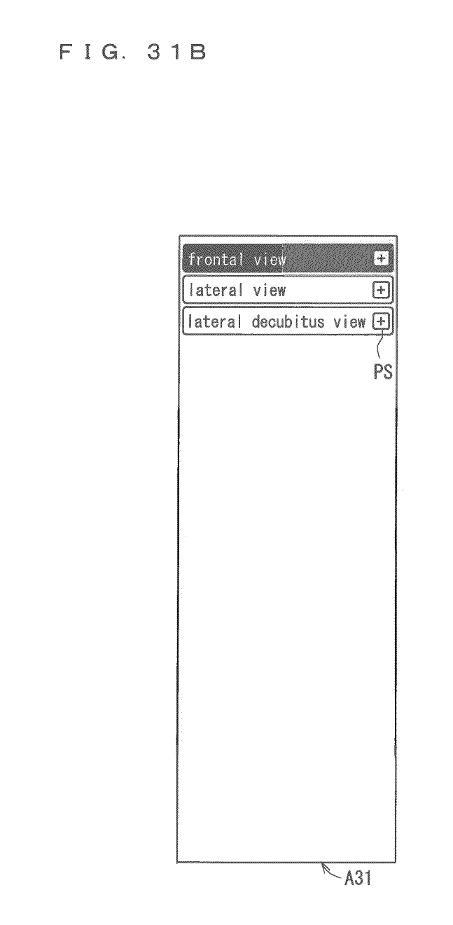

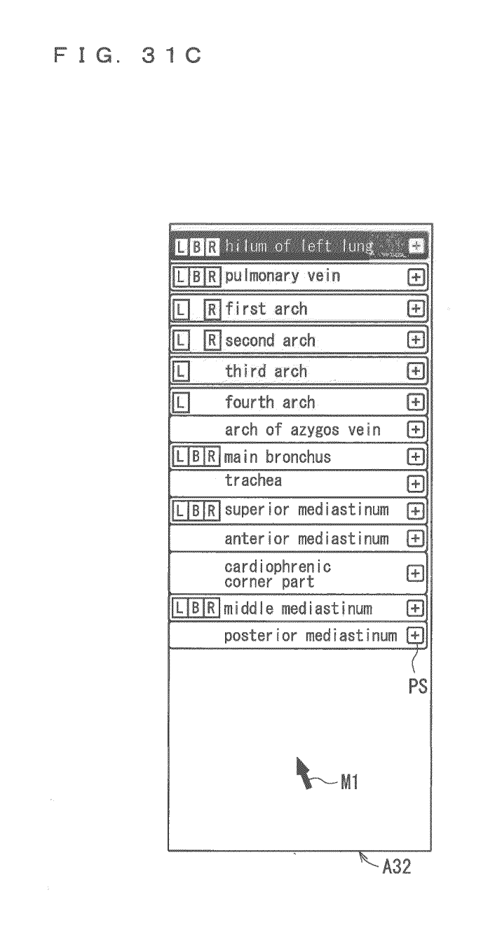

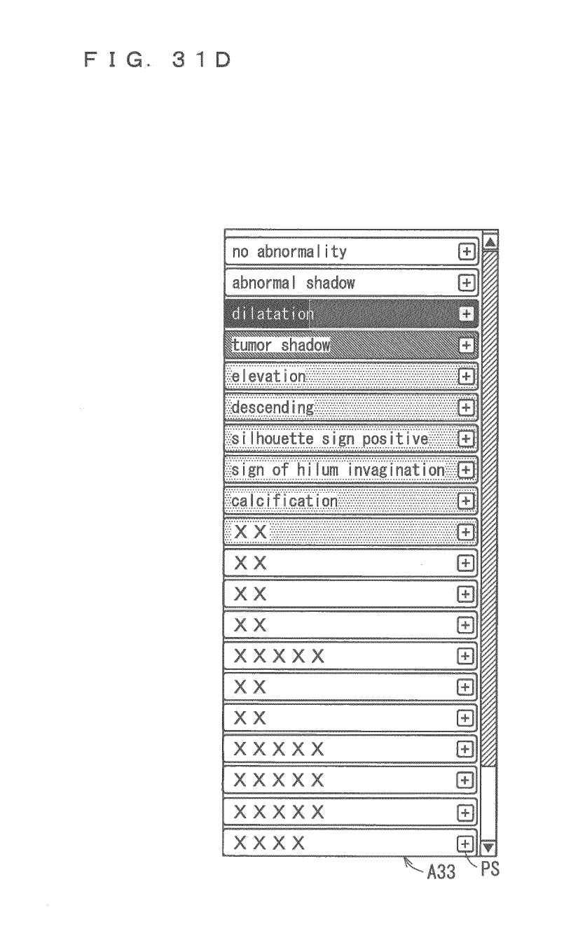

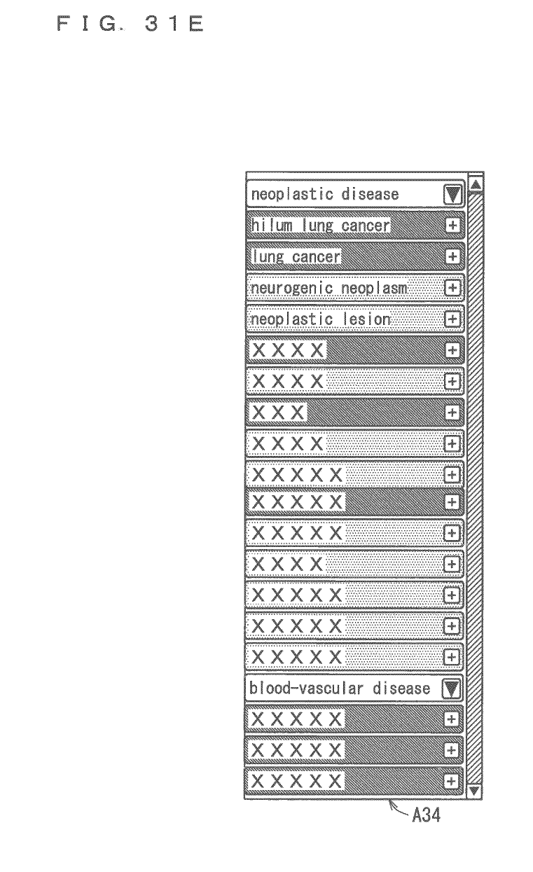

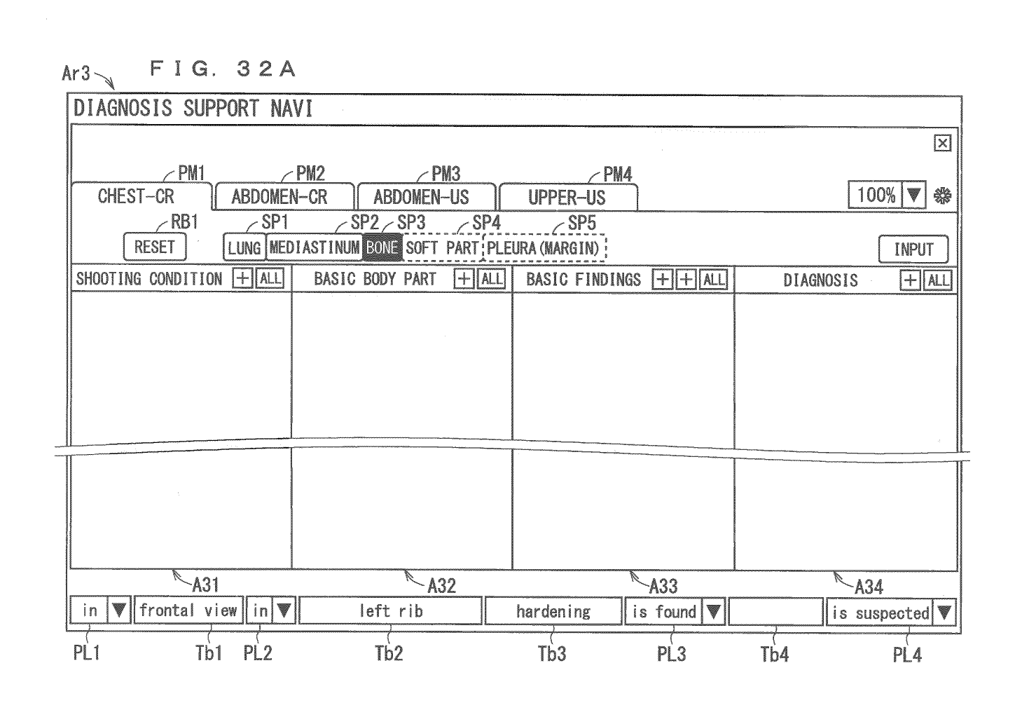

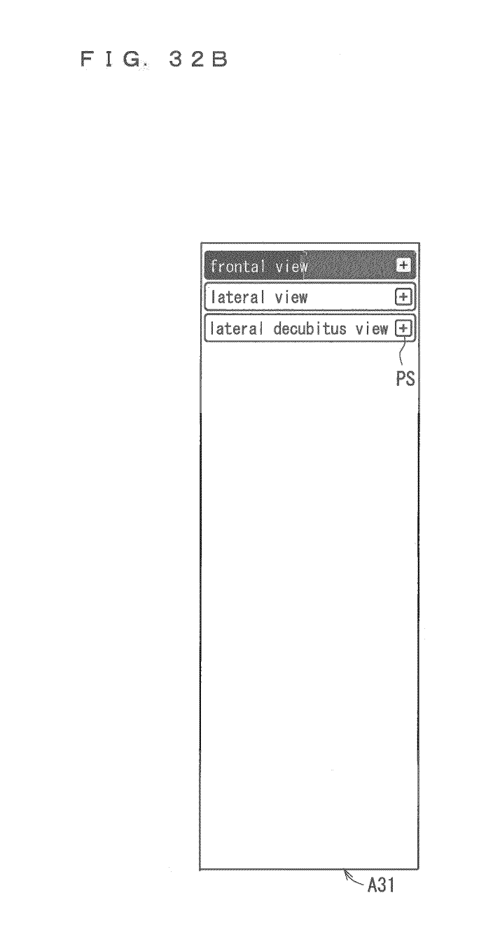

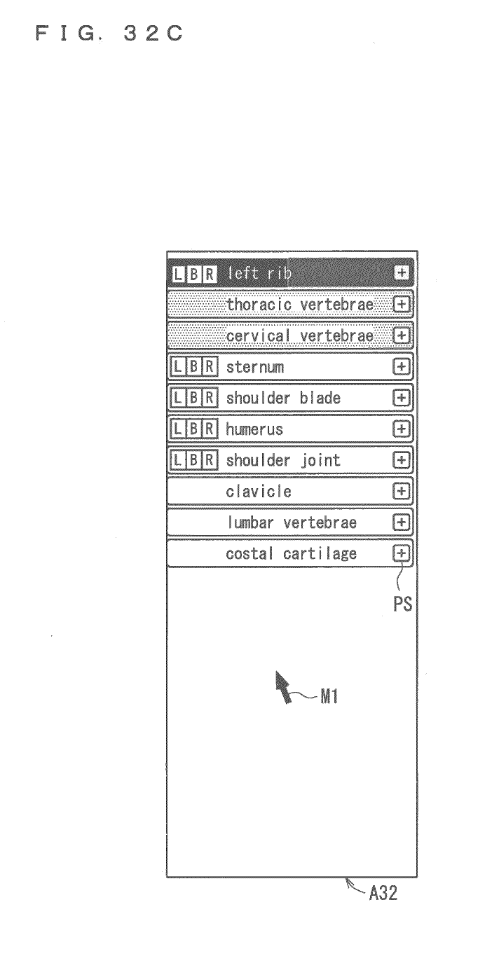

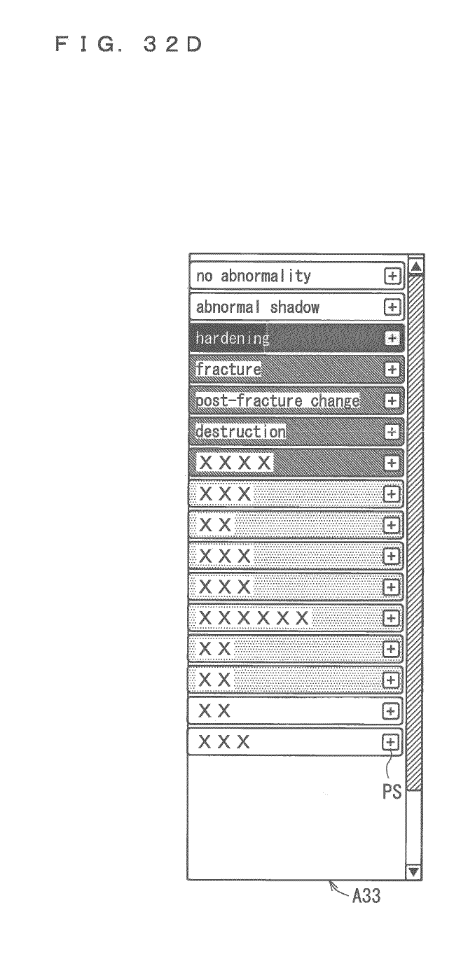

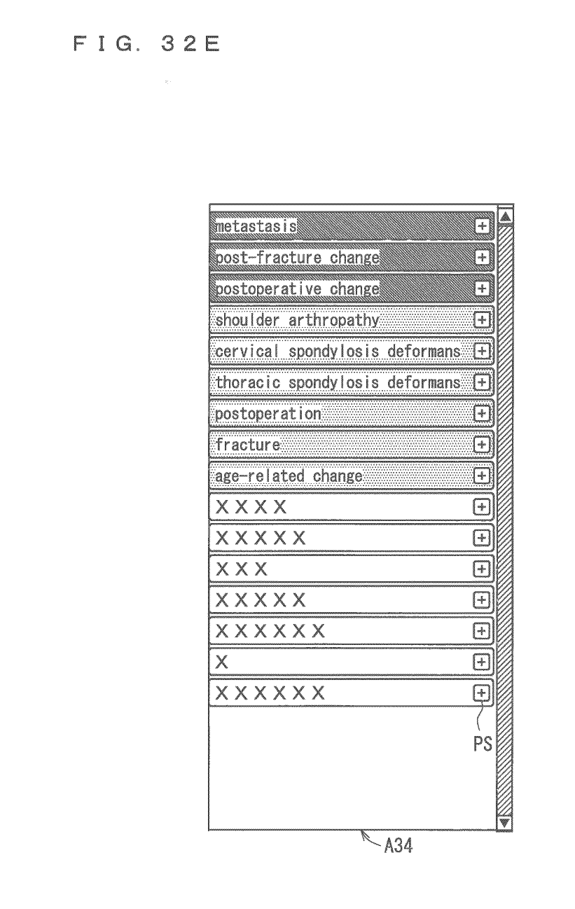

FIGS. 31A to 31E show an example of the support template shown in FIGS. 29A to 29E in a state in which a term “dilatation” is designated as the term that belongs to the item “basic findings”. FIGS. 32A to 32E show an example of the support template shown in FIGS. 30A to 30E in a state in which a term “hardening” is designated as the term that belongs to the item “basic findings”.

In the example of FIGS. 31A to 31E, terms that belong to the item “diagnosis” and are associated with a combination of the term “hilum of a left lung” that belongs to the item “basic body part” and the term “dilatation” that belongs to the item “basic findings” are shown by hatched display elements in the selection area A34. In the example of FIGS. 32A to 32E, terms that belong to the item “diagnosis” and are associated with a combination of the term “left rib” that belongs to the item “basic body part” and the term “hardening” that belongs to the item “basic findings” are shown by hatched display elements in the selection area A34. One or more terms that belong to the item “diagnosis” and are associated with the combination of the designated term that belongs to the item “basic body part” and the designated term that belongs to the item “basic findings” can thus easily be known. As a result, designation of terms in creating a diagnostic result report is further facilitated.

In the examples of FIGS. 31A to 31E and 32A to 32E, density of hatched display elements showing terms that belong to the item “diagnosis” displayed in the term list increases with increasing frequency of appearance of each of the terms in the at least one combination of terms, as in the example of FIGS. 28A to 28E described above. The at least one combination of terms is indicated by the combination frequency information 122d and corresponds to a combination of the one term designated by the body part designation unit 308 and each of the one or more terms designated by the element designation unit 311, and can be identified by the association identification unit 310. One or more terms that belong to the item “diagnosis” and are strongly associated with a combination of the designated term that belongs to the item “basic body part” and the designated term that belongs to the item “basic findings” can thus easily be known. As a result, designation of terms in creating a diagnostic result report is further facilitated.

The diagnosis support processing as described above supports creation of a diagnostic result report with respect to a medical image in which a three-dimensional anatomy of, for example, a chest area is captured, in consideration of not only diagnosis for a specific category “lung” but also diagnosis for other categories “mediastinum”, “bone”, and the like.

### <(5) Summary>

As set forth above, the information processing system 1 according to the present embodiment identifies, upon designation of an attention location in a medical image in which a three-dimensional anatomy is captured, a plurality of terms as a plurality of candidates for a term concerning the basic body part that corresponds to the attention location. With this structure, even general practitioners who, unlike specialists, may have difficulty specifying a “basic body part” at which an abnormal shadow exists while imagining a three-dimensional anatomy from overlapping of shadows in the medical image can accurately specify the “basic body part” at which the abnormal shadow exists. When one of a plurality of terms as a plurality of candidates for the term that belongs to the basic body part is designated, terms that are associated with the designated term and belong to items other than the item “basic body part” are displayed so as to be distinguishable from the other terms. This promotes creation of a diagnostic result report according to the three-dimensional anatomy. As a result, the diagnostic result report can efficiently and properly be created.

### <(6) Modifications>

It should be noted that the present invention is not limited to the above-mentioned one embodiment, and various modifications and improvements can be made without departing from the scope of the present invention.

For example, in the above-mentioned one embodiment, terms that belong to a plurality of items are listed in the term list in the support template. The present invention, however, is not limited to this structure. For example, term lists that each include a plurality of options that belong to a corresponding one of items may be displayed in time sequence. In this case, the display controller 304 causes the display unit 34 to display a first term list, as a first list, that includes one or more terms that belong to the item “basic findings”, which is the second item, and are included in one or more combinations of terms corresponding to the one term designated by the body part designation unit 308. In response to designation of one or more of the one or more terms included in the first term list by the element designation unit 311, the display controller 304 causes the display unit 34 to display a second term list, as a second list, that includes one or more terms that belong to the item “diagnosis”, which is the third item. The one or more terms included in the second term list are included in at least one combination of terms that is indicated by the combination frequency information 122d, which is the combination information group, and corresponds to a combination of the one term designated by the body part designation unit 308 and each of the one or more terms designated by the element designation unit 311. Use of such a structure facilitates creation of a diagnostic result report even in a limited display area.

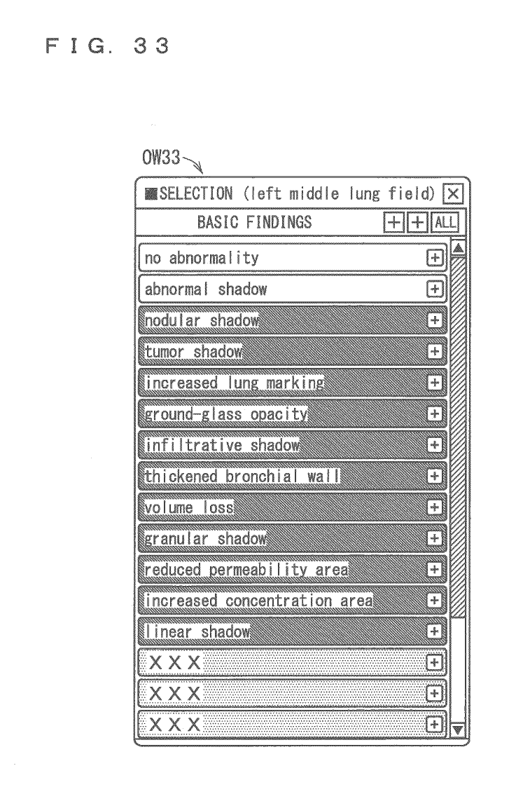

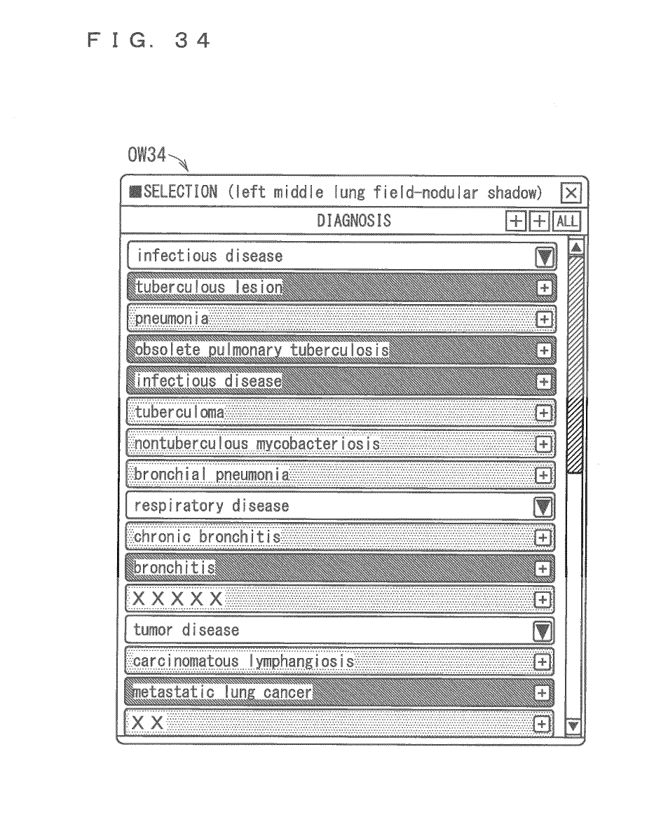

FIGS. 33 and 34 show an example where a term list including a plurality of terms that belong to the item “basic findings” and a term list including a plurality of terms that belong to the item “diagnosis” are displayed in time sequence. FIG. 33 shows a window (also referred to as a finding window) OW33 as the first term list for selecting a term that belongs to the item “basic findings”. The finding window OW33 corresponds to the selection area A33 of the support template in the abovementioned one embodiment. FIG. 34 shows a window (also referred to as a diagnosis window) OW34 as the second term list for selecting a term that belongs to the item “diagnosis”. The diagnosis window OW34 corresponds to the selection area A34 of the support template in the abovementioned one embodiment. For example, the finding window OW33 (FIG. 33) may be displayed in place of the selection areas A31-A34 in step S10 described above, and the diagnosis window OW34 (FIG. 34) may be displayed in place of the selection areas A31-A34 in step S14 described above.

Instead of displaying term lists each including a plurality of terms that belong to a corresponding one of items in time sequence, term lists each including a plurality of terms that belong to a group of two or more items may be displayed in time sequence.

In the above-mentioned one embodiment, a term concerning the shooting condition provided to the medical image is automatically designated as the term that belongs to the item “shooting condition”. The present invention, however, is not limited to this structure. For example, a given term may be designated in the selection area A31 in accordance with an operation on the operation unit 33.

In the one embodiment described above, from among two or more terms as candidates for the term that belongs to the item “basic body part”, a term that has higher priority is designated by the body part designation unit 308 as the term that belongs to the item “basic body part” in an initial state. The present invention, however, is not limited to this structure. For example, the two or more terms as the candidates for the term that belongs to the item “basic body part” identified by the body part identification unit 306 may be displayed as options, and the body part designation unit 308 may designate a term concerning one of the options in response to an operation on the operation unit 33. In this case, the term concerning one of the options may be designated by indirectly designating the term that belongs to the item “basic body part” through pressing of any of the category buttons SP1-SP5, or may be designated by directly designating the term in the selection area A32.

In the one embodiment described above, one of candidates for the term that belong to the item “basic body part” is identified for each term concerning a category. The present invention, however, is not limited to this structure. For example, two or more of candidates for the term that belongs to the item “basic body part” may be identified for each term concerning a category. That is to say, the body part identification unit 306 may identify one or more of candidates for the term that belongs to the item “basic body part” for each term concerning a category. In this case, two or more candidates for the term that belongs to the item “basic body part” may be displayed, as options, for each term concerning a category, and the body part designation unit 308 may designate a term corresponding to one of the options in response to an operation on the operation unit 33, for example.

In the one embodiment described above, the body part designation unit 308 designates a term from among candidates for the term that belongs to the item “basic body part” identified by the body part identification unit 306. The present invention, however, is not limited to this structure. For example, when an appropriate term concerning the items “basic findings” and “diagnosis” cannot be designated in limited candidates for the term that belongs to the item “basic body part” identified by the body part identification unit 306, another term that belongs to the item “basic body part” may be designated.

In the one embodiment described above, the term that belongs to the item “basic body part” is indirectly designated by pressing of any of the category buttons SP1-SP5. The present invention, however, is not limited to this structure. For example, in place of or separately from the category buttons SP1-SP5, candidates for the term that belongs to the item “basic body part” identified by the body part identification unit 306 may be displayed as a plurality of options, and one of the options may directly be designated.

In the one embodiment described above, the body part identification unit 306 identifies candidates for the term that belongs to the item “basic body part” and corresponds to the attention location by performing the first processing and the second processing. The present invention, however, is not limited to this structure. For example, the candidates for the term that belongs to the item “basic body part” and corresponds to the attention location may be identified by performing other processing. As the other processing, a plurality of terms that show names of basic body parts that indicate anatomical sections may be identified from arrangement of bones in the medical image, for example. For example, in a typical chest frontal view, a lower edge of a clavicle corresponds to a center location of an upper lung field, and an upper edge of a diaphragm coincides with a lower edge of a lung field. A range of each anatomical section may thus be identified based on a relationship between a location of the lower edge of the clavicle and a location of the upper edge of the diaphragm, which are identified relatively easily from the chest frontal view, and a term that belongs to the item “basic body part” and indicates an anatomical section corresponding to the attention location may be identified.

In the one embodiment described above, each time the body part designation unit 308 designates the term that belongs to the item “basic body part”, the information extraction unit 309 extracts information corresponding to the designated term that belongs to the item “basic body part” from the combination frequency information 122d. The present invention, however, is not limited to this structure. For example, in response to identification of two or more terms that belong to the item “basic body part” by the body part identification unit 306, the information extraction unit 309 may once extract information pieces corresponding to the respective two or more terms that belong to the item “basic body part” from the combination frequency information 122d. In this case, each time the body part designation unit 308 designates a term that belongs to the item “basic body part”, information corresponding to the designated term that belongs to the item “basic body part” may be extracted from the above-mentioned information extracted once. This allows for smooth processing according to change of the term that belongs to the item “basic body part”.

In the one embodiment described above, the medical care information 121 and the support information 122 are stored in a single storage 12 included in the server 10. The present invention, however, is not limited to this structure. For example, the medical care information 121 and the support information 122 may separately be stored in two or more storage devices included in the storage as appropriate.

In the one embodiment described above, a variety of information is visually output by a single display unit 34. The present invention, however, is not limited to this structure. For example, a variety of information may separately and visually be output by two or more display devices included in the display unit as appropriate. For example, a medical image may be displayed by a first display device and a support template may be displayed by a second display device.

In the one embodiment described above, the support information 122 includes the term information 122c and the combination frequency information 122d. The present invention, however, is not limited to this structure. For example, the support information 122 may include many structured report data pieces. In this case, the many structured report data pieces indicate a plurality of combinations of elements that belong to a plurality of items that include the first item concerning a body part in a three-dimensional anatomy, and the second item and the third item each different from the first item.

In the one embodiment described above, terms are designated for respective items “shooting condition”, “basic body part”, “basic findings”, and “diagnosis” to create a diagnostic result report. The present invention, however, is not limited to this structure. For example, terms may be designated for respective items that include the first item concerning a body part in a three-dimensional anatomy captured in a medical image, and the second item and the third item each different from the first item.

In the one embodiment described above, an instruction signal is input in accordance with a user operation on the operation unit 33. The present invention, however, is not limited to this structure. For example, in response to input of a sound, the sound may be analyzed, and an instruction signal may be input. That is to say, it is sufficient that the instruction signal is input in accordance with a user action.

In the one embodiment described above, an element that belongs to each item is a term. The present invention, however, is not limited to this structure. The element that belongs to each item may be other elements, such as various words and phrases and a diagram that indicates a position and an area.

In the one embodiment described above, various functions for achieving the medical care support processing are shared by the server 10 and the terminal device 30. A ratio of functions achieved by the server 10 to functions achieved by the terminal device 30, however, may be changed as appropriate.

In the one embodiment described above, the information processing system 1 is a server-client system in which the server 10 and the terminal device 30 are connected via the communication line W1. The present invention, however, is not limited to this structure. For example, functions of the above-mentioned information processing system 1 may be achieved by a single computer, assuming that the information processing system 1 is a system in a private hospital.

It should be appreciated that all or part of the one embodiment and various modifications set forth above can appropriately be combined with one another unless any contradiction occurs.

While the invention has been shown and described in detail, the foregoing description is in all aspects illustrative and not restrictive. It is therefore understood that numerous modifications and variations can be devised without departing from the scope of the invention.

What is claimed is:

1. An information processing system comprising:
a storage that is capable of storing therein a combination information group that indicates a plurality of combinations of elements that belong to a plurality of items, the plurality of items including a first item concerning a body part in a three-dimensional anatomy, and a second item and a third item each different from the first item;
a location designation unit that designates, in accordance with a user action, an attention location in a medical image displayed by a display unit;
a body part identification unit that identifies, from among elements that belong to said first item, two or more elements that correspond to said attention location;
a body part designation unit that designates, in accordance with a user action, one of said two or more elements identified by said body part identification unit;
a display controller that causes said display unit to display, based on one or more combinations of elements that are indicated by said combination information group and correspond to the one element designated by said body part designation unit, two or more elements that are included in the one or more combinations of elements and belong to said second item so that the two or more displayed elements are distinguishable from the other elements; and
an element designation unit that designates, in accordance with a user action, one or more of the two or more elements that belong to said second item and are displayed by said display unit, wherein
said display controller causes said display unit to display, based on at least one combination of elements that is indicated by said combination information group and corresponds to a combination of the one element designated by said body part designation unit and each of the one or more elements designated by said element designation unit, one or more elements that are included in the at least one combination of elements and belong to said third item so that the one or more displayed elements are distinguishable from the other elements.

2. The information processing system according to claim 1, wherein
said second item is an item concerning findings, and
said third item is an item concerning diagnosis.

3. The information processing system according to claim 1, wherein
said display controller causes said display unit to
display a list of a plurality of elements based on information on at least one or more combinations of elements indicated by said combination information group, the list including a first part in which elements belonging to said first item are listed for a name of said first item, a second part in which elements belonging to said second item are listed for a name of said second item, and a third part in which elements belonging to said third item are listed for a name of said third item,
display, in response to designation of the one element by said body part designation unit, one or more elements that belong to said second item and are included in the one or more combinations of elements that are indicated by said combination information group and correspond to the one element designated by said body part designation unit in said list in accordance with frequency of appearance in the one or more combinations of elements, and
display, in response to designation of the one or more elements by said element designation unit, one or more elements that belong to said third item and are included in the at least one combination of elements that is indicated by said combination information group and corresponds to the combination of the one element designated by said body part designation unit and each of the one or more elements designated by said element designation unit in said list in accordance with frequency of appearance in the at least one combination of elements.

4. The information processing system according to claim 3, wherein
said display controller causes said display unit to
display, in response to designation of the one element by said body part designation unit, the one or more elements that belong to said second item and are included in the one or more combinations of elements that are indicated by said combination information group and correspond to the one element designated by said body part designation unit in said list so that the one or more displayed elements are distinguishable from one or more remaining elements that belong to said second item, and
display, in response to designation of the one or more elements by said element designation unit, the one or more elements that belong to said third item and are included in the at least one combination of elements that is indicated by said combination information group and corresponds to the combination of the one element designated by said body part designation unit and each of the one or more elements designated by said element designation unit in said list so that the one or more displayed elements are distinguishable from one or more remaining elements that belong to said third item.

5. The information processing system according to claim 1, wherein
said display controller causes said display unit to
display, in response to designation of the one element by said body part designation unit, a first list that shows one or more elements that belong to said second item and are included in the one or more combinations of elements that are indicated by said combination information group and correspond to the one element designated by said body part designation unit, and
display, in response to designation of the one or more elements by said element designation unit from the one or more elements shown by said first list, a second list that shows one or more elements that belong to said third item and are included in the at least one combination of elements that is indicated by said combination information group and corresponds to the combination of the one element designated by said body part designation unit and each of the one or more elements designated by said element designation unit.

6. The information processing system according to claim 1, wherein
said storage is capable of storing therein correspondence information that associates information pieces on locations in a predetermined anatomical model concerning the three-dimensional anatomy with elements that belong to said first item, and
said body part identification unit identifies, from among the elements that belong to said first item, the two or more elements that correspond to said attention location by converting an information piece on said attention location, in said medical image, designated by said location designation unit into an information piece on a location in said anatomical model, and extracting, from said correspondence information, two or more elements that belong to said first item and are associated with the information piece on the location in said anatomical model.

7. The information processing system according to claim 1 further comprising
a storage controller that causes said storage to store therein an information piece on said attention location, in said medical image, designated by said location designation unit, wherein
said display controller causes said display unit to display said attention location on said medical image based on the information piece on said attention location, in said medical image, stored in said storage so that said attention location is distinguishable from a surrounding area.

8. A non-transitory computer readable recording medium storing a computer-readable program, the program controlling an information processing system to operate as one information processing system, and the one information processing system comprising:
a storage that is capable of storing therein a combination information group that indicates a plurality of combinations of elements that belong to a plurality of items, the plurality of items including a first item concerning a body part in a three-dimensional anatomy, and a second item and a third item each different from the first item;
a location designation unit that designates, in accordance with a user action, an attention location in a medical image displayed by a display unit;
a body part identification unit that identifies, from among elements that belong to said first item, two or more elements that correspond to said attention location;
a body part designation unit that designates, in accordance with a user action, one of said two or more elements identified by said body part identification unit;
a display controller that causes said display unit to display, based on one or more combinations of elements that are indicated by said combination information group and correspond to the one element designated by said body part designation unit, two or more elements that are included in the one or more combinations of elements and belong to said second item so that the two or more displayed elements are distinguishable from the other elements; and
an element designation unit that designates, in accordance with a user action, one or more of the two or more elements that belong to said second item and are displayed by said display unit, wherein
said display controller causes said display unit to display, based on at least one combination of elements that is indicated by said combination information group and corresponds to a combination of the one element designated by said body part designation unit and each of the one or more elements designated by said element designation unit, one or more elements that are included in the at least one combination of elements and belong to said third item so that the one or more displayed elements are distinguishable from the other elements.
